(19) United States
(12) Patent Application Publication
(10) Pub. No.: US 2022/0139050 A1
(43) Pub. Date: May 5, 2022

(54) Augmented Reality Platform Systems, Methods, and Apparatus

(71) Applicant: Zanni XR Inc., Morris Plains, NJ (US)

(72) Inventor: David Solomon Rodriguez, Morris Plains, NJ (US)

(73) Assignee: Zanni XR Inc., Morris Plains, NJ (US)

(21) Appl. No.: 17/530,438

(22) Filed: Nov. 18, 2021

Related U.S. Application Data
(63) Continuation-in-part of application No. 29/799,865, filed on Jul. 16, 2021, now Pat. No. D944249.
Application No. 29/799,865 is a continuation of application No. 29/712,226, filed on Nov. 6, 2019.

(51) Int. Cl. G06T 19/00; H04N 13/332; H04L 67/131; H04L 67/52; G02B 30/36

(52) U.S. Cl. CPC G06T 19/006; H04N 13/332; H04N 2213/001; H04L 67/18; G02B 30/36; H04L 67/38

(57) ABSTRACT

Systems, methods, and apparatus are disclosed involving an augmented reality (AR) platform. An exemplary system includes a server and an apparatus, comprising a console and an intermediate computing device. The console includes: a camera adapted to receive reality-based visual image input of targeted content and to generate reality-based video data thereof; and positioning sensors adapted to generate positioning data for determination of the position and orientation of the console. The console is adapted to communicate video data and positioning data to the computing device, which is adapted to communicate with the server and receive from the server augmented-reality overlay data, which the server is adapted to generate based on the positioning data. The computing device is adapted to combine the AR-overlay data and the video data, to generate AR-overlaid video data, and to transmit the AR-overlaid video data to the console, which is adapted to display the AR-overlaid video data.

### CROSS REFERENCE TO RELATED APPLICATION

This application is a continuation in part of U.S. Non-Provisional Design patent application Ser. No. 29/799,865 (“the '865 application”), titled “Apparatus for Supporting an Electronic Viewing Device” and filed Jul. 16, 2021, which is a continuation of U.S. Non-Provisional Design patent application Ser. No. 29/712,226 (“the '226 application”), titled “Apparatus for Supporting an Electronic Viewing Device” and filed Nov. 6, 2019, which are both incorporated by reference herein in its entirety for all purposes.

### BACKGROUND OF THE INVENTION

The invention relates to systems, methods and apparatus involving an augmented reality platform, and in a particular embodiment, to an entertainment and educational system involving at least one console unit coupled to a media server that overlays augmented reality content to a video displayed on the console unit, wherein the augmented reality content is determined based in part on the position, location, orientation, and point of view of the console unit relative to viewable images of targeted content, as viewable from the position, location, orientation, and point of view of the console unit.

The related art includes, for instance, tools, products, and systems to generate augmented reality (“AR) and virtual reality (“VR”). While VR immerses a user into a synthetic computer-generated (“CG”) world with no views of reality, AR superimposes CG images and/or graphics over a real-world view, typically as viewed through an associated camera, thus forming a composite image and allowing for a whole host of visual information to be presented in real time. AR integrates the real world with the virtual content, thereby improving the quality of the user's visual experience. Prior-art AR implementations include smartphone game applications and retailers' applications enabling the “drag and drop” of a retailer's products in images of a customer's room, and while this technology is affordable, it is currently limited to smartphone “apps” of very limited potential, performance, and capabilities.

Most AR experiences today involve overlaying the physical world with known, fixed information. Maps and games have garnered much attention in the consumer tech space. In the industrial world, the AR capabilities typically are centered around visualization, instruction, and guiding. Some examples include the following: virtual work instructions for operating manuals; service maintenance logs with timely imprinted digitized information; and remote guidance connecting company experts to junior level staff with live on-site annotations.

Several companies are attempting to complete consumer-friendly, affordable, and wearable AR devices and AR headsets that attempt to seamlessly blend the real world with current information and updates. Examples of this technology include in-car navigation systems and the use of pins for various home applications such as bathroom mirror weather apps, refrigerator door cooking apps, and bedroom wall pins. The underlying premise is that giving people the ability to automatically access relevant information works better when that information is integrated into a person's perception of the physical world.

Wearable AR glasses and VR devices, also known as Head Mounted Displays (HMDs), have received considerable attention and investigation due to their potential to harmonize human-to-computer interaction and enhance user performance of an activity performed by a user wearing the AR or VR device. The applications for HMDs span the fields of entertainment systems, education & training, interactive controls, 3D visualizations, tele-manipulation, and wearable computers. HMDs and similar “wrap-around headsets” have been suitable for testing, but HMDs are turning out to be impractical for wearing for longer periods of time. HMDs are also expensive, uncomfortable, and have short battery lives. Other drawbacks of HMDs include the use requirements that HMDs must be worn continuously on a user's head, HMDs affect a user's hairstyling, and HMDs continuously press against a user's face, scalp, and skull. Moreover, the ways data are captured, sent, and received by HMDs require more sensors, which further affect HMDs' size, weight, and cost. In addition, AR headsets typically have a limited field of view and do not create solid images for the user.

Besides work being done with HMDs, other developers currently are doing work with wearable glasses, contact lenses, and other lighter headsets. Because wearable glasses, and contact lenses typically involve a wearer looking through the glasses and lenses and seeing the reality visible therethrough, such devices enable only AR experiences, and not VR experiences, inasmuch as VR involves the immersion of the user in an entirely-computer-generated visual experience. AR wearable glasses are meant for daily use working in tandem with smart phone apps and neither the device nor the app is intended for high-end performance.

In contrast to the prior art, the commercially-available product embodiment of the present invention, marketed under the trademark Ovees™, is unique in its design, in its functionality, and in its intended use of the present invention.

Compared to HMDs, the Ovees™ console is lighter, more compact, and easier to use. In contrast to AR glasses, the Ovees™ console is easily switchable between AR and VR.

As described below, embodiments of the present invention include the use of novel features within an augmented reality platform comprising an entertainment and educational system involving console units adapted to customize and augment content presented at a venue, using systems and methods different from those of the prior art systems and methods.

### BRIEF SUMMARY OF THE INVENTION

The invention relates to systems, methods and apparatus involving an augmented reality platform, and in a particular exemplary embodiment, to an entertainment and educational system including a server and an apparatus adapted for generating and displaying in real-time an augmented reality video stream based on a point of view of the apparatus relative to a targeted live-action performance, in which computer-generated content is generated by the server and then is overlaid over a video feed of the live-action performance from a camera on the apparatus.

In accordance with a first aspect of the invention, an apparatus is disclosed that is adapted for use in displaying computer-generated content, in which the apparatus comprises: electronic circuitry and hardware including: a processor; a camera, the camera coupled to the processor; a display, the display coupled to the processor; a memory, the memory coupled to the processor; a positioning device, the positioning device coupled to the processor; a data transfer module, the data transfer module coupled to the processor; a data transfer device, the data transfer device coupled to the processor; electronic software, the software stored in the electronic circuitry and hardware and adapted to enable, drive, and control the electronic circuitry and hardware; an optical lens assembly, the optical lens assembly adapted to magnify and to focus an image rendered and displayed on the display; a power supply connection, the power supply connection coupled to the electronic circuitry and hardware and couplable to a power supply; and a housing, the housing comprising an interior and an exterior housing, the interior containing the electronic circuitry and hardware, the software, and the power supply connection; and the exterior housing comprising a frame enclosing the optical lens assembly.

The positioning device is adapted to generate positioning data indicative of at least one parameter of a group consisting of a position, a location, an orientation, a movement, and a point of view of the apparatus. The computer-generated content includes dynamic content changing over time and space in real-time as related events in reality occur. The dynamic content is selected from a content group consisting of augmented reality content and virtual reality content. The computer-generated content comprises computer-generated content data encoding video. The computer-generated content and computer-generated content data are adapted to be generated based on the positioning data. The computer-generated content is customized to the apparatus based on the computer-generated content data being generated after, but nearly simultaneous to, generation of the positioning data. The computer-generated content is rendered and displayed on the display after, but nearly simultaneous to, generation of the computer-generated content. And, an occurrence of data generated, rendered, or displayed after, but nearly simultaneous to, generation of other data occurs within a latency not to exceed one second.

The data transfer device may be adapted to enable a data transfer between the console and a separate computing device, wherein the data transfer device may be adapted to enable the console to communicate with and transfer the electronic video feed data to the separate computing device and to enable the separate computing device to communicate with and transfer electronic data to the console. The data transfer device may include, for example, a wire cable, a wireless transceiver, or both. The video console may be enabled to transfer to or receive from the separate computing device video data, software, and a configuration file, and the separate computing device may be enabled to transfer to the console other software and files. The wire cable, or a separate power cable, also may be adapted to power the console and/or enable the console to recharge the internal power source when the cable is coupled to an external power source.

In accordance with a second aspect of the invention, a system is disclosed that is adapted for use in displaying computer-generated content, in which the system comprises: a server; and an apparatus, the apparatus adapted to be coupled to and in communication with the server; wherein the server comprises: server electronic circuitry and hardware including: a server processor; a server memory, the server memory coupled to the server processor; a server data transfer module, the server data transfer module coupled to the server processor; a server data transfer device, the server data transfer device coupled to the server processor; server electronic software, the server software stored in the server electronic circuitry and hardware and adapted to enable, drive, and control the server electronic circuitry and hardware; and a server power supply connection, the server power supply connection coupled to the server electronic circuitry and hardware and couplable to a server power supply; wherein the apparatus comprises: apparatus electronic circuitry and hardware including: an apparatus processor; an apparatus camera, the apparatus camera coupled to the apparatus processor; an apparatus display, the apparatus display coupled to the apparatus processor; an apparatus memory, the apparatus memory coupled to the apparatus processor; an apparatus positioning device, the apparatus positioning device coupled to the apparatus processor; an apparatus data transfer module, the apparatus data transfer module coupled to the apparatus processor; an apparatus data transfer device, the apparatus data transfer device coupled to the apparatus processor; apparatus electronic software, the apparatus software stored in the apparatus electronic circuitry and hardware and adapted to enable, drive, and control the apparatus electronic circuitry and hardware; an apparatus optical lens assembly, the apparatus optical lens assembly adapted to magnify and to focus an image rendered and displayed on the apparatus display; an apparatus power supply connection, the apparatus power supply connection coupled to the apparatus electronic circuitry and hardware and couplable to an apparatus power supply; and an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing the apparatus optical lens assembly.

The apparatus positioning device is adapted to generate positioning data indicative of at least one parameter of a group consisting of a position, a location, an orientation, a movement, and a point of view of the apparatus. The apparatus is adapted to transmit the positioning data to the server. The apparatus is adapted to receive the computer-generated content from the server. The server is adapted to generate the computer-generated content based on receiving the positioning data from the apparatus. The server is adapted to transmit the computer-generated content to the apparatus upon generation of the computer-generated content. The computer-generated content includes dynamic content changing over time and space in real-time as related events in reality occur. The dynamic content is selected from a content group consisting of augmented reality content and virtual reality content. The computer-generated content comprises computer-generated content data encoding video. The computer-generated content and computer-generated content data are adapted to be generated by the server based on the positioning data. The computer-generated content is customized to the apparatus based on the computer-generated content data being generated after, but nearly simultaneous to, generation of the positioning data. The computer-generated content is rendered and displayed on the apparatus display after, but nearly simultaneous to, generation of the computer-generated content by the server. And, an occurrence of data generated, rendered, or displayed after, but nearly simultaneous to, generation of other data occurs within a latency not to exceed one second.

In an exemplary embodiment of the system, each apparatus unit may include at least one configuration of the plurality of configurations. A configuration may include, for instance, a map (e.g., an ariel map, a road map, a topography map, a trail map, a resources map, a route map, a perspective view map, a plan view map, a point-of-view map, etc.), a utility (e.g., switch points of view, reveal details, switch profiles, synchronization of accounts, etc.), a terrain (e.g., a city, a town, a village, a planet, a forest, a mountain, an ocean, a valley, a ghetto, a camp, an outpost, a mall, etc.), a tool (e.g., a weapon, a vehicle, a unit or type of ammunition, a unit or type of nutrition, etc.), a capability (e.g., flying, jumping, swimming, telepathy, invisibility, teleportation, etc.), an avatar (e.g., a warrior, a soldier, a spy, a ghoul, a troll, a giant, an alien, a monster, a vampire, a werewolf, a wizard, a witch, an elf, etc.), and a utility (e.g., a social media connection, a message feed, etc.). A user of the platform may be a consumer, a producer, a performer, a developer, an administrator, etc., or combination thereof. A user may create and/or distribute a configuration, or both, by using the platform for user-based creation and/or distribution of configurations. Each configuration may be software code in a configuration file that includes, for instance, one or more of a settings file, a configuration file, a profile file, an applet file, an application file, a plug-in file, an application protocol interface (“API”) file, an executable file, a library file, an image file, a video file, a text file, a database file, a metadata file, and a message file. A producer user may develop the software code for the configuration file using, for instance, programming in coding languages, such as JavaScript and HTML, including open source code, or object-oriented code assembly. The software code would be adapted to be compatible with and executable by the software of a console on which a compatible video may be displayed, with which or within which the configuration would be used.

In an exemplary embodiment, the system may include the apparatus of the first aspect of the invention, in which the apparatus is adapted and configured to interact with the platform. The system further may be adapted to enable, permit, and allow a plurality of users to interact with each other, against each other, with one or more system-generated team members, against one or more system-generated opponents, or a combination thereof.

In accordance with a third aspect of the invention, a method for is disclosed that is adapted for use in displaying computer-generated content, in which the method comprises: providing an apparatus, the apparatus adapted to be coupled to and in communication with a server; generating positioning data of and by the apparatus; transmitting the positioning data from the apparatus to the server; receiving the computer-generated content at the apparatus from the server; and rendering and displaying the computer-generated content on an apparatus display; wherein the apparatus comprises: apparatus electronic circuitry and hardware including: an apparatus processor; an apparatus camera, the apparatus camera coupled to the apparatus processor; an apparatus display, the apparatus display coupled to the apparatus processor; an apparatus memory, the apparatus memory coupled to the apparatus processor; an apparatus positioning device, the apparatus positioning device coupled to the apparatus processor; an apparatus data transfer module, the apparatus data transfer module coupled to the apparatus processor; an apparatus data transfer device, the apparatus data transfer device coupled to the apparatus processor; apparatus electronic software, the apparatus software stored in the apparatus electronic circuitry and hardware and adapted to enable, drive, and control the apparatus electronic circuitry and hardware; an apparatus optical lens assembly, the apparatus optical lens assembly adapted to magnify and to focus an image rendered and displayed on the apparatus display; an apparatus power supply connection, the apparatus power supply connection coupled to the apparatus electronic circuitry and hardware and couplable to an apparatus power supply; and an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing the apparatus optical lens assembly.

The apparatus positioning device is adapted to generate positioning data indicative of at least one parameter of a group consisting of a position, a location, an orientation, a movement, and a point of view of the apparatus. The apparatus is adapted to transmit the positioning data to the server. The apparatus is adapted to receive the computer-generated content from the server. The computer-generated content includes dynamic content changing over time and space in real-time as related events in reality occur. The dynamic content is selected from a content group consisting of augmented reality content and virtual reality content. The computer-generated content comprises computer-generated content data encoding video. The computer-generated content and computer-generated content data are adapted to be generated by the server based on the positioning data. The computer-generated content is customized to the apparatus based on the computer-generated content data being generated after, but nearly simultaneous to, generation of the positioning data. The computer-generated content is rendered and displayed on the apparatus display after, but nearly simultaneous to, generation of the computer-generated content by the server. And an occurrence of data generated, rendered, or displayed after, but nearly simultaneous to, generation of other data occurs within a latency not to exceed one second.

In an exemplary embodiment, the method further may be adapted for entertainment and/or education of a participant, in which the method comprises providing an apparatus adapted for interaction with the participant, in which the apparatus may be configured in accordance with the first aspect of the invention; configuring the apparatus to interact within the system; configuring the apparatus to interact with the participant; enabling the apparatus to interact with the participant; and adapting the apparatus to electronically process video data, configuration data, audio data, video AR-overlay data, or a combination thereof, of an interaction of the apparatus with the participant.

Further aspects of the invention are set forth herein. The details of exemplary embodiments of the invention are set forth in the accompanying drawings and the description below. Other features, objects, and advantages of the invention will be apparent from the description and drawings, and from the claims.

### BRIEF DESCRIPTION OF THE DRAWINGS

By reference to the appended drawings, which illustrate exemplary embodiments of this invention, the detailed description provided below explains in detail various features, advantages, and aspects of this invention. As such, features of this invention can be more clearly understood from the following detailed description considered in conjunction with the following drawings, in which the same reference numerals denote the same, similar, or comparable elements throughout. The exemplary embodiments illustrated in the drawings are not necessarily to scale or to shape and are not to be considered limiting of its scope, for the invention may admit to other equally effective embodiments having differing combinations of features, as set forth in the accompanying claims.

FIG. 1 shows a block diagram of an exemplary embodiment of an apparatus, according to aspects of the invention.

FIG. 2 shows a block diagram of an exemplary embodiment of a method of use of an exemplary apparatus, according to prior art of the invention.

FIG. 3 shows a block diagram of an exemplary embodiment of an operation of the apparatus of the present invention, according to aspects of the invention.

FIG. 4 shows a block diagram of an exemplary computer environment for use with the systems and methods in accordance with an embodiment of the present invention, and according to aspects of the invention.

FIG. 5 shows a block diagram of an exemplary system, and an exemplary set of databases for use within the exemplary computer environment, for use with systems and methods in accordance with an exemplary embodiment of the present invention, according to aspects of the invention.

FIG. 6A to FIG. 6G show various views, respectively a front right perspective view, a front elevation view, a rear elevation view, a right side elevation view, a left side elevation view, a top plan view, and a bottom plan view, of an exemplary apparatus, for use with systems and methods in accordance with an exemplary embodiment of the present invention, according to aspects of the invention.

FIG. 7 shows a conceptual block diagram of an exemplary system functions operation flow within systems and methods in accordance with an exemplary embodiment of the present invention, according to aspects of the invention.

FIG. 8 shows a conceptual block diagram of an exemplary apparatus operation, as an apparatus within a system used pursuant to a method in accordance with an exemplary embodiment of the present invention, according to aspects of the invention.

FIG. 9 shows a conceptual pictographic diagram of an exemplary console and break-out box architecture and included couplings, as an apparatus within a system used pursuant to a method in accordance with an exemplary embodiment of the present invention, according to aspects of the invention.

FIG. 10 shows a block diagram of an exemplary system, in accordance with an exemplary embodiment of the present invention, in which dual wired connections are present for connections of a server to each of eight apparatus, each apparatus comprising a console paired with and coupled to a break-out box connecting to the server via a wired Ethernet connection and a wired HDMI connection, according to aspects of the invention.

FIG. 11 shows a block diagram of an exemplary configuration, of a console (i.e., glasses) and a break-out box having dual wired connections, in accordance with an exemplary embodiment of the present invention, in which dual wired connections are present for connections of a server to each apparatus, each apparatus comprising a console paired with and coupled to a break-out box connecting to the server via a wired Ethernet connection and a wired HDMI connection, according to aspects of the invention.

FIG. 12 shows a block diagram of another exemplary system, in accordance with another exemplary embodiment of the present invention, in which single wired or wireless Ethernet connections are present for connections of a server to each of eight apparatus, each apparatus comprising a console paired with and coupled to a break-out box having a wired or wireless Ethernet connection to the server, according to aspects of the invention.

FIG. 13 shows a block diagram of another exemplary configuration, of a break-out box having a single wired connection to a server, and the break-out box to be separately coupled to a console, in accordance with an exemplary embodiment of the present invention, in which single wired Ethernet connections are present for connections of a server to each apparatus, each apparatus comprising a console paired with and coupled to a break-out box having a wired Ethernet connection to the server, according to aspects of the invention.

FIG. 14 shows a block diagram of a further exemplary configuration, of a break-out box having a single wireless connection to a server, and the break-out box to be separately coupled to a console, in accordance with a further exemplary embodiment of the present invention, in which single wireless connections are present for connections of a server to each apparatus, each apparatus comprising a console paired with and coupled to a break-out box having a wireless transceiver, according to aspects of the invention.

FIG. 15 shows a conceptual pictographic diagram of exemplary couplings in an architecture of a break-out box having a single wired connection to a server, and the break-out box separately coupled to a console (i.e., glasses), in accordance with an exemplary embodiment of the present invention, in which a single wired Ethernet connection is present for connection of a server to the apparatus, the apparatus comprising a console paired with and coupled to a break-out box having a wired Ethernet connection to the server, according to aspects of the invention.

FIG. 16 shows a block diagram of an exemplary embodiment of a method of use of an exemplary system, according to prior art of the invention.

FIGS. 17-24 show front perspective, rear perspective, front elevational, rear elevational, right side, left side, top plan, and bottom plan views of an alternate augmented reality apparatus that may be substituted for the apparatus depicted in FIGS. 6A through 6G without departing from the scope hereof.

### LISTING OF DRAWING REFERENCE NUMERALS

Below are reference numerals denoting the same, similar, or comparable elements throughout the drawings and detailed description of the invention:

| | |
|---|---|
| 10000 | an apparatus |
| 10010 | an augmented reality |
| | console |
| 10012 | an XR console |
| 10020 | a participant |
| 10030 | a power user |
| 11000 | an exterior housing |
| 11100 | a frame |
| 11200 | a handle |
| 11300 | optics |
| 11400 | eye cups |
| 12000 | an interior |
| 12100 | electronic circuitry |
| 12110 | an integrated electronic |
| | hardware system |
| 12111 | an integrated camera |
| 12112 | an integrated |
| | microphone |
| 12113 | an integrated speaker |
| 12114 | an internal processor |
| 12115 | an internal memory |
| 12116 | an internal power |
| | source |
| 12117 | an integrated data |
| | transfer module |
| 12118 | an integrated input |
| | button |
| 12119 | a mini display |
| 12119′ | an illumination device |
| 12120 | an integrated software |
| | operating system |
| 12130 | a dataset |
| 12132 | a first profile |
| 12134 | an augmented reality |
| | application |
| 12136 | an AR configuration |
| 13000 | a data transfer device |
| 14000 | a positioning device |
| 14010 | an accelerometer or |
| | inertia motion unit |
| | (IMU) |
| 14120 | an infrared (IR) sensor |
| 20000 | a method of use of an |
| | AR apparatus 10000 |
| 21000 | a beginning detection |
| 21100 | detecting the input |
| | button being activated |
| 21200 | detecting a command |
| 21300 | detecting motion of the |
| | apparatus |
| 22000 | a beginning response |
| 22100 | playing a greeting, |
| | displaying video, or |
| | other response |
| 22200 | displaying an AR- |
| | overlaid video |
| 23000 | a subsequent detection |
| | and response |
| 23100 | displaying video |
| 23200 | displaying AR overlay |
| 23300 | recording video, with |
| | or without AR overlay |
| 23400 | responding to further |
| | responses |
| 24000 | an ending detection |
| 24100 | detecting an ending |
| 24200 | detecting the input |
| | button being activated |
| 25000 | an ending response |
| 25100 | playing a reply |
| | farewell to the first |
| | participant |
| 25200 | storing a recording of |
| | the interaction as an |
| | interaction audiovisual |
| | file as a computer- |
| | readable file on a |
| | computer-readable |
| | storage medium |
| 30000 | a data transfer device |
| 30010 | a wire cable |
| 30020 | a wireless transceiver |
| 31000 | a data transfer |
| 31100 | electronic data |
| 31110 | a separate device |
| | software application |
| 31120 | an interaction |
| | audiovisual file |
| 31130 | a settings dataset |
| 31140 | an image file |
| 31150 | a AR app |
| 31160 | a AR app |
| | configuration |
| 32000 | an augmented reality |
| | console |
| 32100 | an internal power |
| | source |
| 33000 | a separate computing |
| | device |
| 33010 | a break-out box (BOB) |
| 33012 | a wireless transceiver |
| 34000 | an external power |
| | source |
| 40000 | a computer |
| | environment |
| 41000 | an augmented reality |
| | data system |
| 41100 | an augmented reality |
| | apparatus |
| 42000 | a network |
| 43000 | a network connection |
| 44000 | a computing device |
| 44100 | a smart device |
| 44200 | a mobile phone |
| 44300 | a computer |
| 45000 | a media server |
| 45100 | a media account |
| 45110 | media data selected for |
| | delivery to user device |
| 50000 | a data system |
| 51000 | a computing device |
| 51010 | an augmented reality |
| | apparatus console |
| 51100 | a processor |
| 51200 | a memory |
| 51300 | a volatile memory and |
| | a non-volatile memory |
| 51400 | a removable storage |
| 51500 | a non-removable |
| | storage |
| 51600 | a communications |
| | connection |
| 51700 | an input device |
| 51800 | an output device |
| 52000 | a network |
| 53000 | a server |
| 54000 | a database |
| 54100 | a database |
| 54200 | a database |
| 54300 | a database |
| 54400 | a database |
| 54500 | a database |
| 54600 | a database |
| 55000 | a tracking device |
| 55010 | a beacon device |
| 60000 | a console unit |
| 60010 | a front right |
| | perspective view |
| 60020 | a front elevation view |
| 60030 | a rear elevation view |
| 60040 | a right side elevation |
| | view |
| 60050 | a left side elevation |
| | view |
| 60060 | a top plan view |
| 60070 | a bottom plan view |
| 70000 | a system functions |
| | overview |
| 71000 | a console function |
| 71100 | a console input |
| | function |
| 71200 | a console output |
| | function |
| 72000 | a server function |
| 73000 | a break-out box (BOB) |
| | function |
| 80000 | an apparatus operation |
| 80010 | a view of reality from |
| | a perspective of a |
| | viewer behind the |
| | camera |
| 81000 | a console operation |
| 81100 | a console input |
| | operation |
| 81110 | a front facing camera |
| 81200 | a console output |
| | operation |
| 81210 | a live video feed |
| | output |
| 81220 | an OLED micro- |
| | display |
| 81230 | an optical lens |
| 81240 | an augmented reality |
| | experience output |
| 82000 | a break-out-box (BOB) |
| | operation |
| 82100 | an augmented video |
| | feed output |
| 83000 | a server operation |
| 83100 | a digital content from |
| | the server |
| 90000 | an arrangement of |
| | console and break-out |
| | box architecture |
| | couplings |
| 100000 | a system architecture |
| | with dual connections |
| 110000 | a console and break- |
| | out box dual |
| | connection |
| | configuration |
| 120000 | a system architecture |
| | with single |
| | connections |
| 130000 | a break-out box |
| | architecture with a |
| | single wired |
| | connection |
| 140000 | a break-out box |
| | architecture with a |
| | single wireless |
| | connection |
| 150000 | an arrangement of |
| | console and break-out |
| | box couplings in a |
| | single-connection |
| | architecture |
| 160000 | a method of use of an |
| | augmented reality |
| | system |
| 161000 | an image capture and |
| | positioning detection |
| 161100 | detecting an input |
| 161200 | detecting an image |
| 161300 | detecting motion |
| 162000 | a send of camera video |
| | output and inertia |
| | motion unit (IMU) |
| | data feed |
| 162100 | sending camera video |
| | data feed |
| 162200 | sending IMU data feed |
| 163000 | a server computation |
| | and response |
| 163100 | determining a point of |
| | view (POV) of video |
| 163200 | computing an |
| | augmented reality |
| | (AR) overlay |
| 163300 | sending an augmented |
| | reality (AR) overlay |
| 164000 | a receipt and |
| | combination of |
| | responses |
| 164100 | receiving an |
| | augmented reality |
| | overlay |
| 164200 | combining an |
| | augmented reality |
| | overly and a video feed |
| 165000 | a receipt and display of |
| | an AR-overlaid video |
| 165100 | receiving a combined, |
| | AR-overlaid video |
| | feed |
| 165200 | displaying the AR- |
| | overlaid video feed |

### DETAILED DESCRIPTION OF THE INVENTION

The invention is directed to systems, methods, and apparatus involving a platform and an apparatus adapted to provide an experience of augmented reality (“AR”), virtual reality (“VR”), and/or a combination thereof as a cross reality (“XR”). In an exemplary embodiment of the invention, the apparatus embodies an augmented reality apparatus that includes a handheld console. The apparatus may be adapted to operate as a configurable augmented reality console having electronics, such as a camera, a display, a microphone, a speaker, buttons, and a transceiver, coupled to and controlled by a processor, with the apparatus adapted to be connectable to the augmented reality platform, such as connectable to a media server or system, in a networked environment. In some embodiments, the console may be wired and connectable to a fixed location, while in other embodiments, the console may include an internal chargeable battery and a radio-frequency transceiver, so that the console may be wireless and portable.

In some embodiments of the present invention, a system is provided that comprises an augmented reality platform that connects the augmented reality console to augmented reality overlaid video in a networked environment. The platform and system may provide a dashboard of, for instance, user activity, augmented reality video activity, and console status data.

In some embodiments, video and configurations may be educational in nature and function as learning tools to develop, practice, or reinforce a user's skills or knowledge of specific information or content, such as a manual skill. Various embodiments of the inventions may use augmented reality in one or more of entertainment, education, guidance and training, communications, conferencing, trade shows, healthcare, air traffic control, and the auto industry.

Commercial Embodiments of the Ovees™ System

A commercial embodiment of the present invention is being brought to the market under the trademark Ovees™ AR product and system. The Ovees™ AR apparatus is a proprietary handheld mixed reality viewer that enables XR-enhanced performances, placing augmented reality content in the context of a live performance or show. Unlike prior art devices, this device can achieve both augmented reality and virtual reality, giving the producer the ability to take the audience in and out of completely occluded virtual spaces. Producers will also be able to use this product to conduct virtual staging prior to investing in physical buildout, minimizing wasted costs and time.

The Ovees™ Ecosystem links high quality video cameras, micro displays, optics, tracking technology, artificial intelligence (“AI”), embedded software, media servers, and real time image rendering, all working in tandem to create the augmented reality. The Ovees™ apparatus allows engineering, media, and design teams to create a robust system inside an Ovees™ ecosystem.

The Ovees™ apparatus works within a larger ecosystem, and its design is based on a mix of established standards and protocols used in theatrical production, live broadcast, gaming, and the creation of visual effects. An exemplary preferred embodiment of this ecosystem works in collaboration with the following exemplary technologies: (a) Unreal Engine by Epic Games: a visual rendering software originally designed for the gaming industry that has become the leader in real-time animation, visual effects for film & tv, and most VR/AR applications, which provides the digital assets that are overlaid onto the live video feed inside the Ovees™ ecosystem; (b) Disguise XR Media Server: the backbone or central control unit for visual media in theatrical productions and live entertainment that has recently become the go-to device for the use of LED stages in Virtual Production, which allows for Ovees™ apparatus to communicate with the larger network and provides the scaling power to have just one or several thousand pairs of Ovees™ devices working in tandem; and (c) Open XR by Khronos Group: a cross-platform standard for VR/AR devices that enables applications and engines to run on any system that exposes the OpenXR APIs, wherein using this open-source software as the communication bridge allows developers to use an Ovees™ apparatus in the same way they would for other HMDs, like the Oculus, Vive Pro, or HP Reverb; and wherein the Ovees™ ecosystem should benefit from this OpenXR Technology as it will be highly compatible with all existing AR and VR products.

The Ovees™ apparatus is adapted to enrich a user's view of stages and scenes and enhances reality when desired. It allows users to choose between an actual live world and an “augmented” one. Anticipated use cases include: Opera, Theatre, Stage Performances, Concerts, Sports Events, Sports Venues, Theme Parks; and Museums. Activities may include a live stage and theatre performance, but also includes applications for sports events, theme parks, conferences, classrooms, medical and defense industry training and other industrial uses. For instance, uses may include in Live Entertainment, such as Theatre, Stage, Conferences, Concerts, Theme Parks (Disney); Sports Events (Immersive Lounges for fans and spectators to “enhance” the games they watch); Live and Pre-Recorded Education, Guidance, Learning, Training; Traditional Education; Learning Experiences & Immersive Learning Environments; and Business Processes & Procedures: Business Enterprise and Industry (architecture, construction, utilities; air traffic control, tele-robotics, automobiles, communications, healthcare, surgery, and anesthesiology).

An Ovees™ unit can be held or positioned in a console; the unit easy to use, and no bulky headset is involved. The Ovees™ console is modeled after traditional opera glasses and provides a stereoscopic 3D display to completely change and upgrade a user's view of reality. The Ovees™ console include at least one optical lens assembly adapted to magnify and to focus an image rendered and displayed on a display, such as a high-resolution OLED micro-display. Although the commercial embodiment of the Ovees™ console includes one lens assembly and one micro-display per eye, for a total of two lens assemblies and two micro-displays to provide the stereoscopic 3D imagery, an alternative embodiment may be adapted for use with a single eye, like a telescope, and include just a single lens assembly and a single micro-display, without providing the stereoscopic 3D imagery. The Ovees™ console has been designed in the spirit of an iconic pair of opera glasses with a stick holding up binocular-type lenses. However, the handle may be detachable to allow the binocular-style embodiment to be held in one hand or in two hands in a manner similar to holding a pair of binoculars. An alternative embodiment akin to a telescope likewise may include the handle, and the handle may be detachable to allow the telescope-style embodiment to be held in a hand in a manner similar to holding a telescope. If wiring or cables traverse the handle, the handle may be detachable in a manner either to detach, remove, and reattach the wiring and cables, to separate the wiring and cables from the handles, and/or detach the wiring and cables without reattaching them, such as in using the console in a wireless fashion, in which the console includes a wireless transceiver, for data, a battery, as a power supply.

While old opera glasses were used solely for magnification, the Ovees™ system augments what is physically being viewed. For example, with an Ovees™ console, a user can also see a computer-generated boulder sliding off a mountain or a 3D fire-breathing dragon flying across the stage added to the actual view. What had once taken the staging team months to develop and to implement can now be observed via computer-generated images transmitted to the Ovees™ glasses, which is the central part of a system that integrates high-quality video cameras, micro-displays, optics and tracking technology to create an augmented reality for the viewer.

In addition, an Ovees™ console could also be utilized for Virtual Reality (“VR”) experiences, because the Ovees™ console can also accommodate Virtual Reality feeds if and when desired. In contrast to existing VR devices that require headsets or other bulky frames, the Ovees™ console provides a solution to the question of how to develop an AR opera, and the related question “How are we going to get a bunch of people who just got their hair done for the opera to put on a bulky headset”?

System Overview: The Ovees™ system achieves an AR experience by a process known as “digital pass-through” that transforms the real-world view of the user through a live video stream captured by a built-in camera and merges this data with CG objects generated by a real-time rendering software. The new “augmented” video is quickly displayed on two internal micro-OLED displays, one for each eye, which are magnified with a right and left lens piece made up of multiple lenses. Instead of seeing the physical reality in front of them, the user now views an “augmented” reality by simply holding up and looking through a pair of Ovees™ “opera glasses.”

Unit Overview: Inside an exemplary commercial Ovees™ console are two “glasses” that include optical lenses in front of two OLED micro displays, one for each eye, creating a fully immersive visual effect. A user holds an Ovees™ console by a center-positioned handle, which is connected to two lens assemblies, one for each eye. A front-facing camera sits on a bridge between the left and right lens assemblies and is adapted to capture a live recording of an on-stage performance, sending this video information out through a cable that runs down the length of the handle. The cable also may include a data connection to transmit positioning data from positional tracking captured by an Inertia Motion Unit (“IMU”) inside the Ovees™ device. The cable and/or the handle may provide a connection to a power supply as well as.

Operation Overview: Every VR or AR device must compensate for the inherent time delay as data transfers from one device to another, also referred to as latency. To minimize the time between what happens in the real-world and the augmented version seen by the viewer, the inventors of the present invention devised a solution that gives the hand-held device a reduced latency, and preferably the smallest degree of latency. This solution comes in the form of a tethered Break-Out Box, aptly named “BOB”, which houses an Nvidia Jetson Xavier NX carrier board with the power of Artificial Intelligence. The single front-facing camera, hidden behind the front left window, captures the real-world view of the user and relays the video feed from the on-board driver inside the Ovees™ console to the Jetson carrier board inside BOB. The video signal may be transferred over a coaxial cable, such as at a rate of 4 Gb/s, that may be housed within the handle and exit out the bottom of the stem. In addition to the video output, a USB 2.0 cable may take the positional and rotational tracking data of the internal IMU sensor from the right circuit board inside Ovees™ to the connector board within BOB. The USB also may travel down the handle stem alongside the video cable and two HDMI input cables later described.

Computing Environment Overview: For any VR/AR device to function properly, the device must run in tandem with several external devices, creating a larger ecosystem of outside hardware and software. Two important pieces of equipment for a quality experience are a high-powered computer and graphics interface. In the case of the Ovees™ apparatus, the Ovees™ console includes a dedicated CPU that integrates with network server being used in the live production. In addition, the Ovees™ system may include a dedicated media server having solid real-time image rendering software, which is required to produce the virtual CG elements that overlay on top of the real-world video feed provided by the camera described above. The Ovees™ embodiment includes the Unreal Engine by Epic Games for real-time rendering. The Unreal Engine is used by many developers to create best-in-class visual graphics for Hollywood VFX, AAA Games, Virtual Production, and Live Broadcast. At the point in the process at which the server receives the video data and the positioning data, the real-time power of Unreal Engine takes over.

Using the tracking data of Ovees™ sensors, and the virtual assets created by a team of CG artists, the software renders out the digital overlay based on the exact perspective of the individual viewer's Ovees™ console. In some embodiments, the same ethernet cable that brought the tracking data may be used by the media server to send back to BOB the real-time virtual overlay. The next step in the AR process is where the true magic of embedded software and Artificial Intelligence (AI) come to life. Using the immense power of the Nvidia Jetson technology, a carrier board inside BOB may be adapted take the live video feed from the camera and overlay the virtual images received from the media server. The augmented images then may be instantaneously split into two separate stereoscopic videos, one for each eye of the viewer. The right and left video data may be sent to the Ovees™ console over the two HDMI input cables. The last steps happen back inside Ovees™ console, where the two HDMI cables terminate at their respective left and right micro-OLED display drivers. The Ovees™ commercial embodiment uses a micro-display made by eMagin Corporation and is only 12.4×9.945 mm (15.9 mm diagonal (0.62″)) in viewing size (equivalent to the size of a dime). Finally, the images running on the displays are magnified through right and left eye pieces, in the same manner as a pair of binoculars or microscope. In less time than the blink of an eye, the real world is visually altered. This is the power of real-time technology and the enhanced immersive experience of the Ovees™ system.

Augmented Reality Client-Server System Specification Overview: The Ovees™ system uses software having various libraries and communication protocols used to provide an Artificial Intelligence (AI)-powered Augmented Reality overlay to the Ovees™ system running on Jetson Xavier NX. Such software may include: (a) ROS2 Robotic Operating System, and (b) the OpenXR Library.

ROS2 Robotic Operating System: The ROS2 Robotic Operating System is adapted to provide the communication and modularity between the server and the Jetson Xavier NX inside the Ovees™ break-out box BOB may be handled by the ROS2 Library, which includes a set of libraries for distributed systems, where each program is represented as a node. Nodes can communicate with each other in two possible ways: (1) Publisher-Subscriber Communication (one-to-many): a publisher node pushes messages on a given topic to which other nodes subscribe, and messages are received through the subscription; and (2) Service-Client Communication (one-to-one): a client node sends a request to a server node, and once the server node handles the service request, it sends the response back to the client.

ROS2 supports running nodes in a single process (all nodes run concurrently in a single process), in multiple processes (nodes run in different processes within a single machine), and across various devices. Depending on the localization it picks the best means of transport for topic messages, service requests, and responses.

Apart from intra-process and inter-process communication of parallelly running nodes, the ROS2 library provides lots of useful data packets and libraries for vision, robotics, and system control. Another advantage of using ROS2 is the requirement of explicitly defining the message and service data structures using specification files to make the communication concise. ROS2 also supports both C++ and Python scripting. The commercial Ovees™ system uses the newest distribution release of ROS2, presently Galactic Geochelone at the time of filing.

OpenXR Library: OpenXR Library is an open standard for extended reality libraries, implementing drivers for a Head Mounted Display (HMD) and Application Programming Interfaces (APIs) for applications running Virtual Reality (VR) and Augmented Reality (AR) features (collectively referred as “XR”). OpenXR can be thought of as OpenGL for VR/AR, not providing the implementation, but the API. The implementation is dependent on the running operating system and there are various implementations of OpenXR that are conformant with the standard.

Monado is an open-source implementation of the OpenXR library that is fully conformant with the OpenXR standard, according to its published tests. Monado fully supports Linux OS and has partial support for Windows. The Monado implementation of OpenXR is referred as the “OpenXR Library”.

The OpenXR library acts as integrator between HMD hardware and the rendering libraries (such as OpenGL, Vulkan, Unity or Unreal Engine 4). The OpenXR library can fetch and process data from various XR related sensors, such as hand controllers, HMD sensors, and trackers, and communicate them via semantic paths (i.e., /user/head represents inputs from the on the user's head, coming from HMD, while /user/hand/left represents the left hand of the user).

The OpenXR Library handles the interactions between the reality and the rendered scene, first localizing the user in the rendered space and then rendering the HMD view based on the user's state. This process occurs on the Jetson Xavier NX board inside BOB, rendering the final views displayed inside the Ovees™ console.

Surrounding Texture Node: The computer-generated (CG) content providing the visual overlay for the AR display may be rendered on a remote server. The rendered content is sent in the form of a texture representing the various perspectives or viewpoints of the rendered scene. This is packed into a single ROS2 message or node called Surrounding Texture.

The initial Ovees™ commercial embodiment of the Surrounding Texture node uses a volumetric cube, which provides a texture with 6 faces or points. Other volumetric shapes containing more individual faces (cylinder, sphere, etc.) may be used, once fully tested. The choice of volumetric shape or number of faces necessary is dependent on the AR function being performed by the Ovees™ system. This dependency allows for more flexibility in the artistic design and provides a technical production solution for scaling up or down.

The Surrounding Texture node may be conceptualized as a transparent image representing the following 6 points of a cube: +X right view; −X left view; +Y top view; −Y bottom view; +Z front view; −Z back view. The initial direction of the points, for example, may be the vector pointing towards the center of the stage or one perpendicular to the viewing area. The cubic texture is extracted from the scene using framebuffers inside the designated render engine. In the case of an exemplary Ovees™ console, this framebuffer would be the equivalent frame buffer inside Unreal Engine 4 (UE4). As the direction of the point's view is changed, respective of the initial direction, a framebuffer is extracted with the desired resolution. The 6 points or volumetric faces of the rendered scene may be packed into a single ROS2 message by the remote server. This Surrounding Texture Node may be sent to and received by BOB for the final image processing to create the Augmented Reality.

Distributed AR Rendering: An exemplary embodiment for the Ovees™ Augmented Reality system creates a ROS2-based distributed system between the remote rendering server and the device based on the Jetson NX Xavier module. For example, the remote server may be adapted to: (1) render the AR content only of a 3D scene using a real-time render engine (i.e., UE4); (2) create a surrounding texture for a single point in the scene; and (3) pack it into a ROS2 message and publishes it under the /render_server/surroundingtexture topic. The ROS2 publishing can be handled inside UE4 with blueprint codes or in the C++ implementation, depending on the implementation method. Likewise, for example, the Jetson NX Xavier may be adapted to: (1) subscribe to /render_server/surroundingtexture topic; (2) collect the new Surrounding Texture when it arrives; (3) fetch the camera frame and IMU sensor data from the Ovees™ console; (4) render the camera view and Surrounding Texture using OpenGL to create the augmented view; and (5) using OpenXR, combine the augmented view with the sensory data and render the final view for the device's internal displays.

Alternate embodiments may include generating Surrounding Texture for multiple points in the scene simultaneously to capture different points of view and publish them under different topics. Each Ovees™ consoles then may pick the Surrounding Texture that is closest to the console. This grouped broadcast process may create the potential of scaling the number of devices used at once within the same production and AR system.

Drawings of Exemplary Embodiments of the Invention

Referring to the Figures, an apparatus may comprise a computing device operable as a video console, may be connectable to an augmented reality platform via a networked environment, and may comprise part of and/or communicate with a media server platform or system, which may include a data system, including at least one server and at least one database, and a network system, including computing devices in communication with each other via network connections.

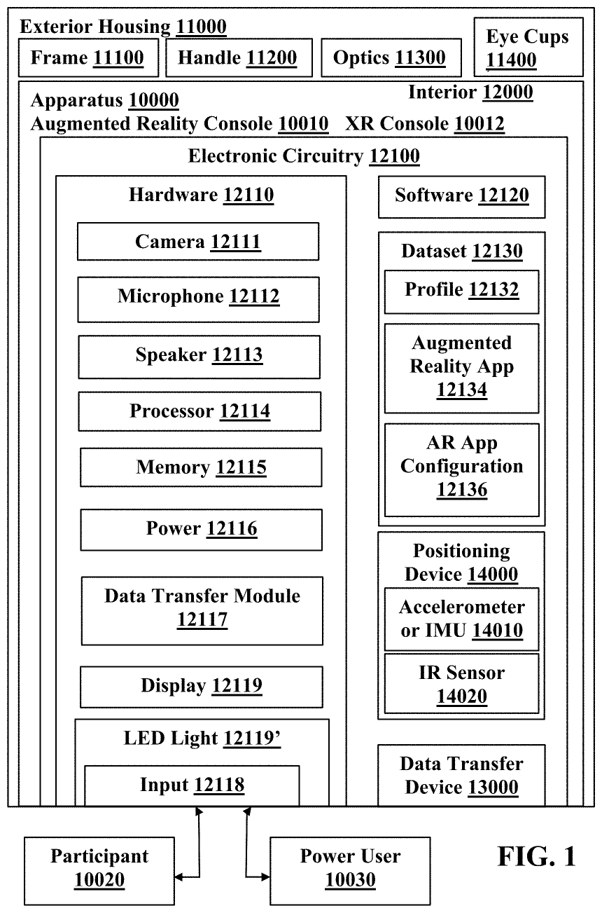

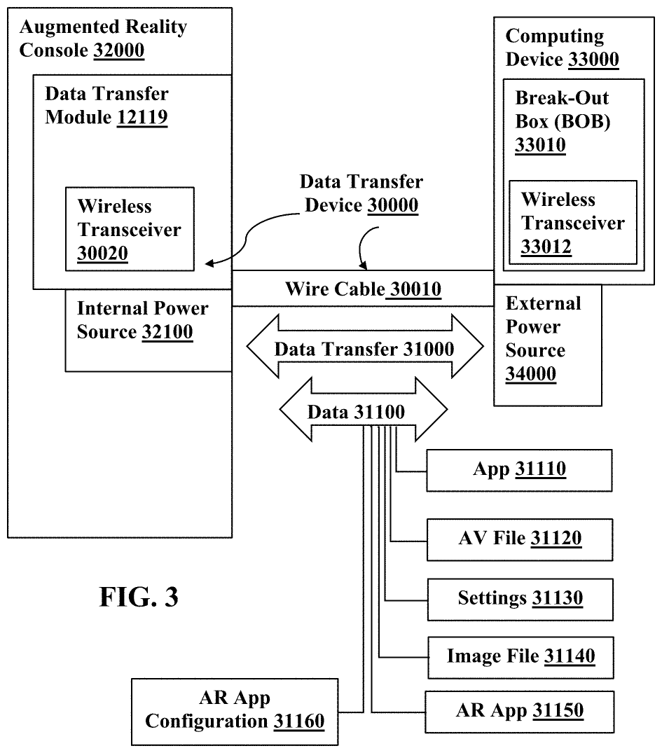

Referring to FIG. 1, FIG. 1 shows a block diagram of an apparatus 10000 adapted to comprise and/or operate as an AR console 10010, and more specifically a configurable XR console 10012, or other configurable device like a tablet computer or smart device, such as a mobile smartphone. The apparatus 10000 may be self-contained, if sufficient computing power and memory are integrated therein, or the apparatus 10000 may comprise and/or interoperate with a separate computing device, as depicted in FIG. 3 et seq. The apparatus 10000 may be configured for interactive communication adapted for entertainment and education of participants 10020. As explained below, the apparatus 10000 may be a part of a larger system, such as an augmented reality platform and/or a virtual reality platform or system. As depicted, the apparatus 10000 comprises a video console 10010, having an exterior housing 11000, such as that of a configurable XR video console 10012, and having an interior compartment 12000 containing electronic circuitry 12100. The housing 11000 may include a frame 11100, a handle 11200, a lens assembly or optics 11300, and eye cups 11400. Each optical lens assembly 11300 preferably includes an eye cup 11400 adapted to conform to a shape of a user's face surrounding an eye socket of the user. As such, the eye cup 11400 may be made from a suitably pliable, resiliently bendable and distortable material, such as rubber, silicon, vinyl, etc. The frame 11100 may define the interior 11000 and enclose the optical lens assembly.

The apparatus 10000 includes a data transfer device 13000 adapted to interoperate with the electronic circuitry 12100. The data transfer device 13000 may include one or more wired and/or wireless communication modules, as explained relative to FIG. 3.

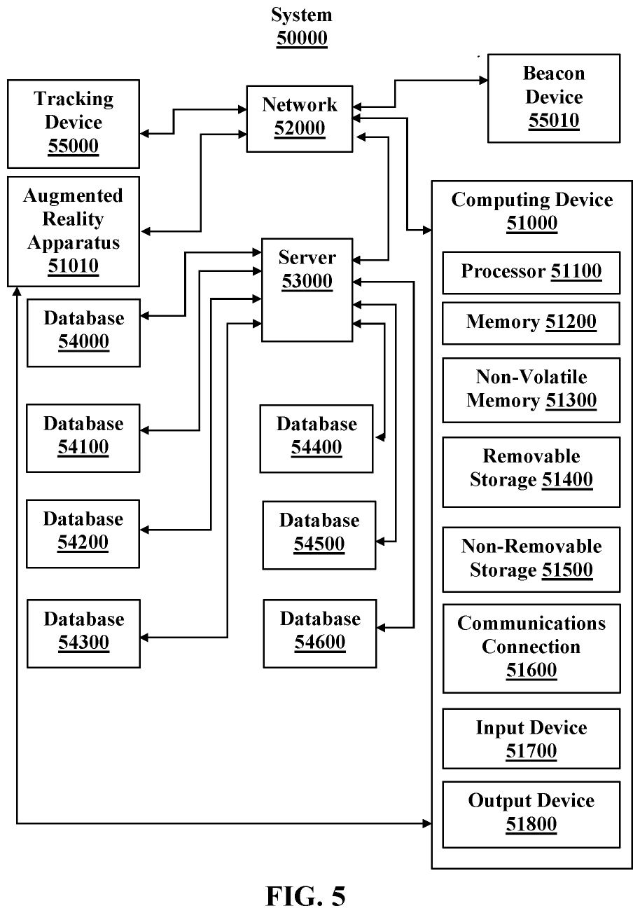

The apparatus 10000 includes a positioning device 14000 adapted to generate positioning data for use in determining the position, orientation, movement, motion, and/or perspective of console 10010. The positioning device 14000 also may be called a position measurement device. The positioning device 14000 generates data about the relative position of the apparatus, but does not “position” the apparatus, in the sense that a tripod might support or “position” the apparatus in a fixed position. The positioning device 14000 may include a global positioning system (GPS) receiver and/or GPS module, from which an “absolute” position relative to Earth might be measured and calculated, but the importance of the positioning device 14000 for the apparatus 10000 relates more to the relative point of view of the apparatus 10000 than to the absolute location of the apparatus 10000. Exemplary positioning devices 14000 may include a gyroscope, an accelerometer, an inertia motion unit (IMU) 14010 and/or an infrared (IR) sensor 14020 or other sensor that may be adapted to detect on-stage beacons or other tracking devices (see FIG. 5) that emit signals suitable for triangulation of a location of the console 10010. In some embodiments, a sensor may comprise a sensor-transmitter pair (e.g., light detection and ranging, “LiDAR”) for active range determinations. Alternatively, the software 12120 may be programed to recognize on-stage artifacts, captured in the video data by the camera 12111, using machine vision and/or artificial intelligence (AI) for determination of the location of the console 10010, such as using triangulation or comparable AI calculation.

The electronic circuitry 12100 includes an integrated electronic hardware system 12110 and an integrated software operating system 12120 stored and executable on the integrated electronic hardware system 12110. The software 12120 may include, for example, firmware, an operating system, applications, drivers, libraries, and application programming interfaces. The electronic software 12120 may be stored in the electronic circuitry 12100 and hardware 12100 and may be adapted to enable, drive, and control the electronic circuitry 12100 and hardware 12100. The integrated electronic hardware system 12110 may include, for instance, one or more printed circuit boards (PCB), such as a motherboard, integrating an integrated camera 12111, an integrated microphone 12112, and an integrated speaker 12113 coupled to an internal processor 12114 coupled to an internal memory 12115 an internal power source 12116, an integrated data transfer module 12117 interoperable with the data transfer device 13000, and at least one integrated input device 12118 (e.g., button, switch, dial, slider, keypad, keyboard, joystick, touchpad, fingerprint sensor, camera, photosensor, infrared sensor, microphone, audio sensor, motion sensor, gyroscope, accelerometer, inertia motion unit, etc.) operable from without the exterior housing 11000. The processor 12114 may include a central processor unit (CPU), a graphics processor (i.e., a graphics card or video card), or combination thereof. The software 12120 and the hardware 12110 may be adapted to enable a power user 10030 to set up the configurable video XR console 10012, such as to create in the software 12120 and store in the memory 12115 a dataset 12130 including a first profile 12132 identifying a first participant 10020, and to download, install, select, and run an augmented reality app 12134 and an AR app configuration 12136 for, and compatible with, a configurable app, such as AR app 12134.

The hardware 12110 further includes a mini display 12119, and preferably two mini displays 12119 (one per eye), and wherein the software 12120 is adapted to render on the display 12119, for instance, a reality-based video, an AR-overlaid video, a VR video, a settings menu, an audiovisual file, an image file, on-screen text, on-screen text-entry icons, or any combination thereof. In some embodiments, the display 12119 is touch-sensitive. Although the display 12119 may emit light, such as using a backlight or illuminated pixels, the hardware 12110 further may include a simple illumination device 12119′ adapted to illuminate at least a portion of the exterior housing 11000. For instance, the illumination device 12119′ may include a light emitting diode (LED) adapted to illuminate a portion of the exterior housing 11000 surrounding the input button 12118. An LED light 12119′ may indicate a status of the console 10010.

Various data settings of the apparatus 10000 may include creating the first profile 12132 to include, for example, entering a first name of the first participant 10020 or power use 10030, or a name of a stage performance, and storing a first face image of a face of the first participant 10020 or power use 10030, or an image indicative of the stage performance. The camera 12111 and the software 12120 may be adapted to recognize the face of the first participant 10020 or power use 10030 based on a comparison with the first face image. The user may associate the first face image with the user's profile for inclusion in the user's postings on the online gaming platform or social media system. Moreover, the configuration 12136 may be specific to the user's profile and may be configured to load automatically upon recognizing the face of the first participant 10020 or power use 10030 within a specified distance of the apparatus 10000.

Among other possible variations, the software 12120 may be further adapted to enable the power user 10030 to select one of a plurality of languages programmed into the software 12120; to select one of a plurality of settings programmed into the software 12120; to set up the first profile by entering first profile parameters including a first performance, a first role, a first seat number, a first theater, a first concert, or any combination thereof, relative to the first participant and/or first performance; and to configure the software 12120 to adjust interaction parameters based on the first profile parameters entered.

Technical variations may include, for example, having the camera 12111 and the software 12120 adapted to measure ambient light, motion, or both, such that the apparatus 10000 may be adapted to alternate between an inactive state and an active state based on measuring a presence or an absence of a minimum threshold of ambient light, motion, or both.

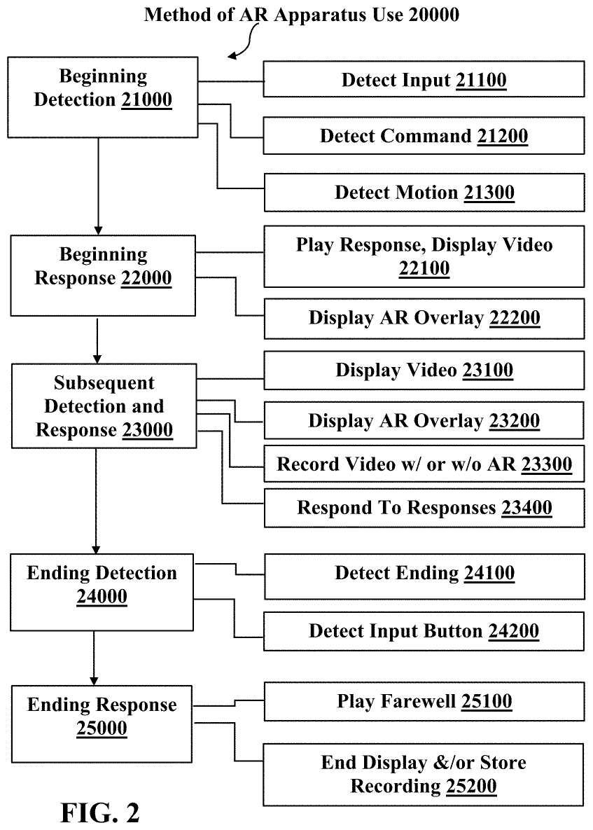

Referring to FIG. 2, FIG. 2 shows a flow diagram of an exemplary method 20000 of using an AR apparatus 10000, such as the apparatus 10000 of FIG. 1, according to aspects of the invention. The method 20000 may be adapted to perform, upon detecting an AR app configuration 12136, loading a configuration beginning detection 21000, a beginning response 22000. For example, the beginning detection 21000 may include detecting the input button being activated (21100), detecting a command being provided (21200), detecting motion of the console (21300), or any combination thereof. Likewise, the beginning response 22000 may include using the speaker to play audio or display video (22100), such as a greeting identifying the first participant 10020, to display an AR overlay (22200), such as instructing the first participant 10020 what to expect during the performance, or to activate the input button 12118 to launch the AR configuration 12136, or both, upon detecting the beginning detection 21000. Following the beginning response 22000, the method 20000 may be adapted to perform a subsequent detection and response 23000, such as display video 23100 from the camera 12111, display an AR overlay 23200 in the video feed, record video (with or without AR overlay) 23300 as an interaction audiovisual file in the memory 12115, such as a AR-overlaid video (23300) of an interaction (e.g., performance being viewed) of the first participant 10020 with the video console 10010, during which interaction the video console 10010 may use the speaker 12113 to play a plurality of verbal instructions or other recordings (23400) responsive to input or verbal responses of the first participant 10020.

The configured apparatus 20000 may be configured to have the software 12120 and the hardware 12110 further be adapted to enable a power user 10030 to set up the apparatus configuration 20000 to select an ending detection 24000 and an ending response 25000 to the ending detection 24000, wherein the method 20000 further is adapted to perform the ending response 25000 upon detecting the ending detection 24000. The ending detection 24000 may include, for instance, detecting an ending 24100, such as the end of the performance, detecting the input button 24200 being activated, such as to discontinue viewing, or both, and the ending detection 24000 may initiate the ending response 25000 that concludes an interaction of the method 20000 with the first participant 10020. The ending response 25000 may include using the speaker to play a reply farewell 25100 to the first participant, ending the display of the video feed, and/or storing a recording 25200 of the interaction as an interaction audiovisual file as a computer-readable file on a computer-readable storage medium. The ending response 25000 might also include connecting to the network, connecting to a media server or platform, and sending an alert to the power user to notify the power user that a participant has concluded interacting with the apparatus 10000 and that a video of the interaction may be available on the media server and/or stored in the video console 10010.

Referring to FIG. 3, FIG. 3 shows a block diagram of an exemplary embodiment 30000 of the present invention specific to a data transfer device 13000. A data transfer device 30000 may be adapted to enable a data transfer 31000 between an AR console 32000 and a separate computing device 33000, such as a break-out box (BOB) 33010 or a server of an AR platform, wherein the data transfer device 30000 may be adapted to enable the AR console 32000 to communicate with and transfer electronic data 31100 to the separate computing device 32000 and to enable the separate computing device 33000 to communicate with and transfer electronic data 31100 to the AR console 32000. The data transfer device 30000 may include, for instance, a wire cable 30010, a wireless transceiver 30020, or both, possibly in combination with wireless transceiver 33012 of BOB 33010, wherein the AR console 32000 may be enabled to transfer to, or receive from, the separate computing device 33000, for example, a separate device software application 31110 and an interaction audiovisual file 31120. Wired cables may include, for instance, an Ethernet cable, RJ45 cable, coaxial cable, USB cable, Thunderbolt cable, Lightning cable, HDMI cable, VGA cable, MIDI cable, etc. A wireless transceiver 30020, 33012 may comprise, for instance, a WiFi transceiver; WiLAN transceiver; a Bluetooth transceiver or a Bluetooth Low Energy (BLE) transceiver; a 1G, 2G, 3G, 4G, or 5G cellular transceiver; a Long-Term Evolution (LTE) cellular transceiver, etc. Likewise, the separate computing device 33000 may be enabled to transfer to, or receive from, the AR console 32000, for instance, a settings dataset 31130 and an image file 31140. For example, an app 31110 might include an AR app 31150, and settings 31130 might include an AR app configuration 31160. In addition, the wire cable 30010 may be adapted to enable the AR console 32000 to recharge an internal power source 32100 when the wire cable 30010 is coupled to an external power source 34000. An internal power source 32100 may include, for instance, a rechargeable battery, a non-rechargeable battery, a battery backup, an uninterrupted power supply (UPS), a solar-powered generator, a photovoltaic cell or array of cells, etc.

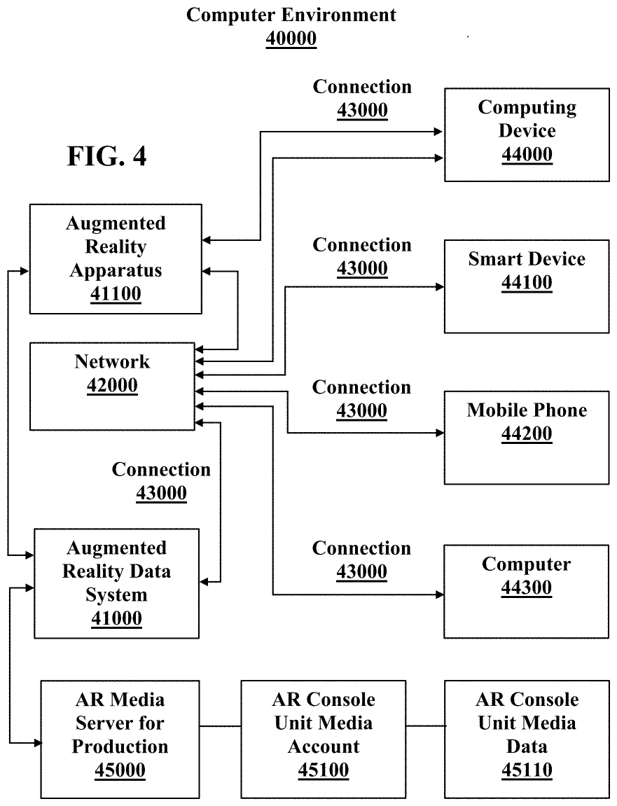

Referring to FIGS. 4-5 below, exemplary embodiments of the present invention may include a system for interactive communication adapted for entertainment and education of a participant, wherein the system comprises an AR platform, and possibly an integrated media server platform, a networked media server, and/or a third-party media server, platform, or service, and an apparatus adapted to interact with AR platform and the media platform. The system further may comprise a separate device software application running on at least one separate computing device, wherein the separate device software application may be adapted to enable the separate computing device to interact with the AR console, modify settings of the AR console, upload data and files to the AR console, download data and files from the AR console, and control features and functions of the AR console.

The system further may comprise a remote computing network and a user account platform accessible via the remote computing network and adapted to communicate with and transfer electronic data to and from the AR platform and the AR console, adapted to communicate with and transfer electronic data to and from the separate computing device, and adapted to enable the AR console to communicate with and transfer electronic data to and from the separate computing device via the remote computing network. The system further may comprise a user account accessible via the user account platform that enables the power user to log into the user account to remotely manage, view, and share data and settings of the AR console and the user's account on the AR platform that are available in the user account via the remote computing network, either because the data and settings have been uploaded to the user account platform, or because the AR console is in communication with the user account platform via the remote computing network while the power user is accessing the user account platform and logged into the user account. In some embodiments, the user account may be adapted to enable the power user to set alert options to have an alert generated and sent to the separate computing device if an interaction with the first participant happens and notification of the interaction has been communicated from an AR console and the user account platform via the remote computing network. The user account further may be adapted to enable the power user to email, upload, download, otherwise electronically share, or any combination thereof, an AR app, an AR app configuration, or other data file, such as an interaction audiovisual file of a recording of an interaction of the first participant with the AR console.

The system further may comprise an AR app configuration data file stored on the remote computing network and downloadable from the user account platform to the separate computing device and to the AR console, wherein the AR configuration data file is adapted to enable the AR console to add further features, perform additional functions, or both. An AR configuration may include, for instance, details relevant to a performance or experience, such as a map (e.g., an ariel map, a road map, a topography map, a trail map, a resources map, a route map, a perspective view map, a plan view map, a point-of-view map, etc.), a utility (e.g., switch points of view, reveal details, switch profiles, synchronization of accounts, etc.), a terrain (e.g., a city, a town, a village, a planet, a forest, a mountain, an ocean, a valley, a ghetto, a camp, an outpost, a mall, etc.), a tool (e.g., a weapon, a vehicle, a unit or type of ammunition, a unit or type of nutrition, etc.), a capability (e.g., flying, jumping, swimming, telepathy, invisibility, teleportation, etc.), a avatar (e.g., a warrior, a soldier, a spy, a ghoul, a troll, a giant, an alien, a monster, a vampire, a werewolf, a wizard, a witch, an elf, etc.), and a utility (e.g., a social media connection, a message feed, etc.). At the level of the AR console, the further features might be selected from the group consisting of further music recordings, further video recordings, further voice recordings, and further illumination patterns; and wherein the additional functions might be selected from the group consisting of additional alert options, additional rules options, additional language options, additional voice recognition options, and additional video recognition options.

A user of the AR platform may be, for instance, a consumer of AR video, a concert goer, a theater goer, a performer, a producer, a developer, an educator, a trainer, an advertiser, a vendor, or any combination thereof. A user may create and/or distribute an AR video, an AR configuration, or both, by using the AR platform for user-based creation and/or distribution of AR videos, AR overlays, and AR configurations. Each AR configuration may be software code in a configuration file that includes, for instance, one or more of: a settings file, a configuration file, a profile file, an applet file, an application file, a plug-in file, an application protocol interface (“API”) file, an executable file, a library file, an image file, a video file, a text file, a database file, a metadata file, and a message file. A user may develop the software code for the AR configuration file using, for instance, programming in coding languages, such as JavaScript and HTML, including open-source code, or object-oriented code assembly. The software code would be adapted to be compatible with and executable by the AR software of an AR console on which a compatible AR video may be displayed, with which or within which the AR configuration would be used.

Referring to FIG. 4, FIG. 4 shows a diagram of an exemplary computer environment for use with the systems and methods in accordance with an embodiment of the present invention, and according to aspects of the invention. FIG. 4 illustrates a schematic diagram of an exemplary computer environment 40000 for creating, receiving, sending, exchanging, updating, and processing data in accordance with an embodiment of the present invention.

In the depicted embodiment, computer environment 40000 includes, inter alia, AR data system 41000, network 42000, connections 43000, and at least one computing device 44000, such as computing devices smart device 44100, mobile smartphone 44200, and tablet computer 44300. The data system 41000 may comprise an AR apparatus 41100 for use in an AR platform, possibly with its own integrated media server and/or service, or connectable to a third-party media server and/or system 45000 for media content, such as for a production. The network 42000 may connect to an AR media system 45000 that accesses an AR console media account 45100 for the transfer of AR console media account data 45110. Computing devices 44100, 44200, and 44300 are connected to network 42000 via connections 43000, which may be any form of network connection known in the art or yet to be invented. Connections 43000 may include, but are not limited to, telephone lines (xDSL, T1, leased lines, etc.), cable lines, power lines, wireless transmissions, and the like. Computing devices 44100, 44200, and 44300 include any equipment necessary (e.g., modems, routers, etc.), as is known in the art, to facilitate such communication with the network 42000. AR data system 41000 is also connected to network 42000 using one of the aforementioned methods or other such methods known in the art.

Using an apparatus and a system such as at depicted in FIGS. 1, 4-5, a user may access the computer environment 40000 via a computing device connected to network 42000 such as computing device 44000. Computing device 44000 may include a break-out box (BOB) 33010, which may function as an intermediate computing device for use between AR apparatus 41100 and AR data system 41000. Such a computing device may be, for instance, the commercial embodiment of the Ovees™ BOB 33010, or alternatively an individual's personal computer, an Internet café computer, an Apple iPod™, a computerized portable electronic device (e.g., a personal data assistant, cell phone, etc.), or the like. Using the apparatus and system exemplified in FIGS. 1 and 4-5, such user access may include a download of data to, and/or an upload of data (e.g., an electronic form of information) from, a computing device 44100, 44200, and 44300 via network 42000 to AR data system 41000 (e.g., server, mainframe, computer, etc.), wherein AR data system 41000 is typically provided and/or managed by the entity implementing the process or its affiliate, subcontractor, or the like.

Although the systems and methods disclosed herein have focused on embodiments in which user access initiates the process, one of skill in the art may easily appreciate that such systems and methods may be equally applied for other scenarios in which the process is not initiated by the user, and in which the process proceeds under the control of the AR data system 41000, which may initiate the AR experience upon the commencement of concert, a production, a play, etc.

Referring to FIG. 5, FIG. 5 shows a block diagram of an exemplary data system for use with systems and methods in accordance with an exemplary embodiment of the present invention, according to aspects of the invention. In addition, FIG. 5 shows an exemplary set of databases, libraries, or data tables for use with the exemplary computer environment, in accordance with the exemplary embodiment of the present invention, according to aspects of the invention. FIG. 5 depicted herein represents an exemplary computing system environment for allowing a user of system 50000 to perform the methods described with respect to FIGS. 1-4.

The depicted computing system environment is only one example of a suitable computing environment and is not intended to suggest any limitation as to the scope of use or functionality. Apart from the customized AR apparatus 51010, numerous other general-purpose or special-purpose computing devices, system environments or configurations may be used, within appropriate application-specific customizations. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

FIG. 5 depicts an exemplary system 50000 for implementing embodiments of the present invention. This exemplary system includes, inter alia, one or more computing devices 51000, a network 52000, and at least one server 53000, which interface to each other via network 52000. A computing device 51000 may include an AR console 32000 of an AR apparatus 51010, a break-out box 33010 of an apparatus 51010, and/or an AR apparatus 51010 having a break-out box 33010 connected to the AR console 32000, such as described in the embodiments of FIGS. 1-3. In its most basic configuration, computing device 51000 includes at least one processing unit, processor 51100, and at least one memory unit 51200. Depending on the exact configuration and type of the computing device, memory 51200 may be volatile (such as random-access memory (“RAM”)), non-volatile (such as read-only memory (“ROM”), solid state drive (SSD), flash memory, etc.), or some combination of the two. This most basic configuration is illustrated in FIG. 5 by non-volatile memory 51300. In addition to that described herein, computing devices 51000 can be any web-enabled handheld device (e.g., cell phone, smart phone, or the like) or personal computer including those operating via Android, Apple, and/or Windows mobile or non-mobile operating systems.

Computing device 51000 may have additional features and/or functionality. For example, computing device 51000 may include additional storage (removable and/or non-removable) including, but not limited to, magnetic or optical disks or tape, thumb drives, and external hard drives as applicable. Such additional storage is illustrated in FIG. 5 by removable storage 51400 and non-removable storage 51500.

Computing device 51000 typically includes or is provided with a variety of computer-readable media. Computer-readable media can be any available media that can be accessed by computing device 51000 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 51200, removable storage 51400, and non-removable storage 51500 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium that can be used to store the desired information, and that can accessed by computing device 51000. Any such computer storage media may be part of computing device 51000 as applicable.

Computing device 51000 may also contain a communications connection 51600 that allows the device to communicate with other devices. Such communications connection 51600 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 51000 may also have input device(s) 51700 such as keyboard, mouse, pen, camera, light sensor, motion senor, infrared (IR) sensor, accelerometer, inertia motion unit (IMU), voice input device, touch input device, etc. Output device(s) 51800 such as a display, speakers, LED light, printer, etc. may also be included. Some input devices 51700 may be considered output devices 51800 for other components, such as a camera providing a video feed, or a sensor providing data on the activity that is sensed. All these devices are generally known to the relevant public and therefore need not be discussed in any detail herein except as provided.

Notably, computing device 51000 may be one of a plurality of computing devices 51000 inter-connected by a network 52000. As may be appreciated, network 52000 may be any appropriate network and each computing device 51000 may be connected thereto by way of connection 51600 in any appropriate manner. In some instances, each computing device 51000 may communicate with only the server 53000, while in other instances, computing device 51000 may communicate with one or more of the other computing devices 51000 in network 52000 in any appropriate manner. For example, network 52000 may be a wired network, wireless network, or a combination thereof within an organization or home, or the like, and may include a direct or indirect coupling to an external network such as the Internet or the like. Likewise, the network 52000 may be such an external network.

Computing device 51000 may connect to a server 53000 via such an internal or external network. Server 53000 may serve, for instance, as an AR platform, a media server, service, or platform, or both. Although FIG. 5 depicts computing device 51000 located in close proximity to server 53000, this depiction is not intended to define any geographic boundaries. For example, when network 52000 is the Internet, computing device can have any physical location. For example, computing device may be a tablet, cell phone, personal computer, or the like located at any user's office, home, or other venue, etc. Or computing device could be located proximate to server 53000 without departing from the scope hereof. Also, although FIG. 5 depicts computing devices 51000 coupled to server 53000 via network 52000, computing devices may be coupled to server 53000 via any other compatible networks including, without limitation, an intranet, local area network, or the like.

The system may use a standard client server technology architecture, which allows users of the system to access information stored in the relational databases via custom user interfaces. An application may be hosted on a server such as server 53000, which may be accessible via the Internet, using a publicly addressable Uniform Resource Locator (“URL”). For example, users can access the system using any web-enabled device equipped with a web browser. Communication between software component and sub-systems are achieved by a combination of direct function calls, publish and subscribe mechanisms, stored procedures, and direct SQL queries.

In some embodiments, for instance, server 53000 may be an Edge 8200 server as manufactured by Dell, Inc., however, alternate servers may be substituted without departing from the scope hereof. System 50000 and/or server 53000 utilize a PHP scripting language to implement the processes described in detail herein. However, alternate scripting languages may be utilized without departing from the scope hereof.

An exemplary embodiment of the present invention may utilize, for instance, a Linux variant messaging subsystem. However, alternate messaging subsystems may be substituted including, without limitation, a Windows Communication Foundation (“WCF”) messaging subsystem of a Microsoft Windows operating system utilizing a .NET Framework 3.0 programming interface.

Also, in the depicted embodiment, computing device 51000 may interact with server 53000 via a Transmission Control Protocol/Internet Protocol (“TCP/IP”) communications protocol; however, other communication protocols may be substituted.

Computing devices 51000 may be equipped with one or more Web browsers to allow them to interact with server 53000 via a HyperText Transfer Protocol (“HTTP”). HTTP functions as a request-response protocol in client-server computing. For example, a web browser operating on computing device 51000 may execute a client application that allows it to interact with applications executed by server 53000. The client application submits HTTP request messages to the server. Server 53000, which provides resources such as HTML files and other content, or performs other functions on behalf of the client application, returns a response message to the client application upon request. The response typically contains completion status information about the request as well as the requested content. However, alternate methods of computing device/server communications may be substituted without departing from the scope hereof.

In the exemplary system 50000, server 53000 includes one or more databases 54000 as depicted in FIG. 5, which may include a plurality of libraries or database tables including, without limitation, Templates, Users, Events, User Uploads, Admin Info, Transactions, Status, Tracking, and/or Location database tables, e.g., 54100 through 54600. As may be appreciated, database(s) 54000 may be any appropriate database capable of storing data and it may be included within or connected to server 53000 or any plurality of servers similar to 53000 in any appropriate manner.

In the exemplary embodiment of the present invention depicted in FIG. 5, database(s) 54000 may be structured query language (“SQL”) database(s) with a relational database management system, namely, MySQL as is commonly known and used in the art. Database(s) 54000 may be resident within server 53000. However, other databases may be substituted without departing from the scope of the present invention including, but not limited to, PostgreSQL, Microsoft® SQL Server 2008 MySQL, Microsoft® Access®, and Oracle databases, and such databases may be internal or external to server 53000.

The various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application programming interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a system 50000 or a distributed computing environment 40000. Still further, aspects of the presently disclosed subject matter may be implemented in or across a plurality of processing chips or devices, and storage similarly may be created across a plurality of devices in system 50000. Such devices might include personal computers, network servers, and handheld devices (e.g., cell phones, tablets, smartphones, etc.), for example.

In the exemplary embodiment, server 53000 and its associated databases are programmed to execute a plurality of processes including those shown in FIGS. 1-3 as discussed in greater detail herein.

Methods in accordance with aspects of the invention include, for instance, a method for interactive communication adapted for entertainment and education of a participant, wherein the method comprises providing an apparatus adapted for interaction with the participant, such as apparatus 10000; configuring the apparatus to interact with the participant; enabling the apparatus to interact with the participant; and capturing electronically in the apparatus audio data, video data, or both, of an interaction of the apparatus with the participant. Further embodiments of the method may include performing the actions associated the functionalities set forth in FIGS. 1-5, such as within the AR console apparatus 10000, within the computing environment 40000, and within the system 50000.

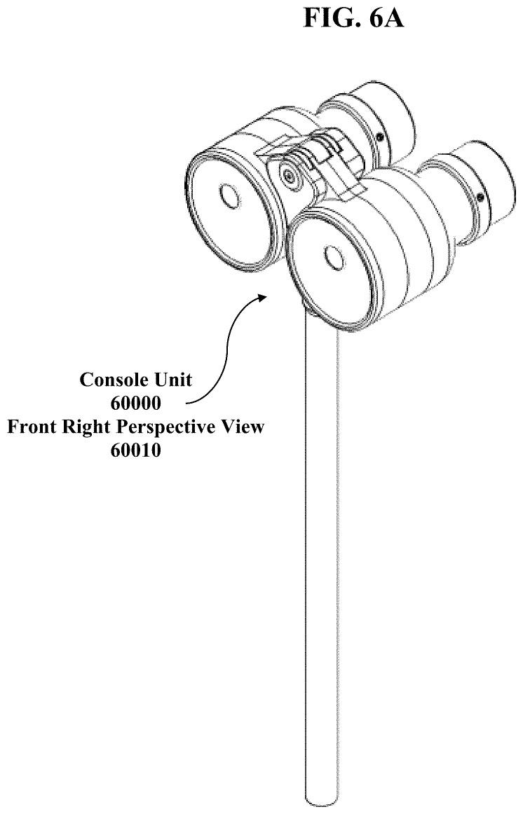

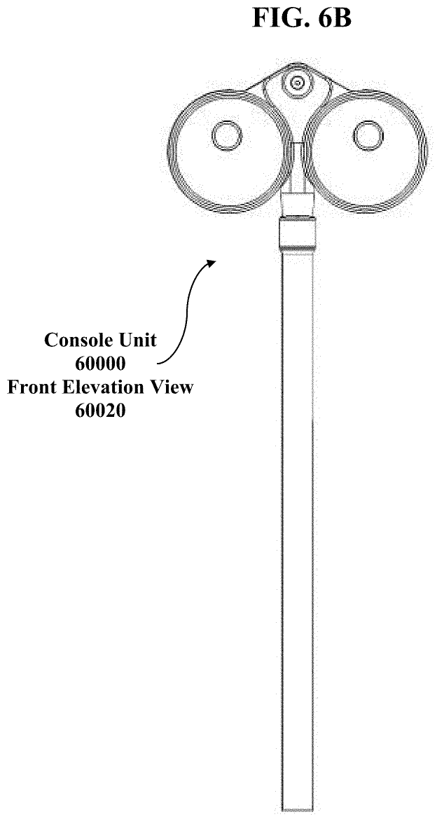

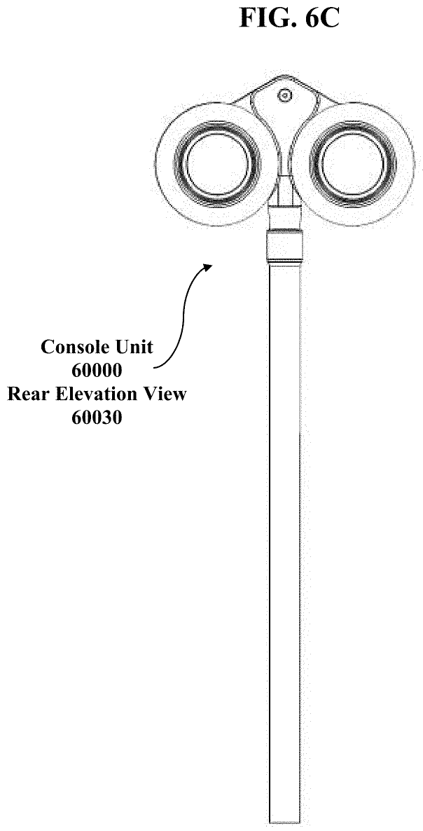

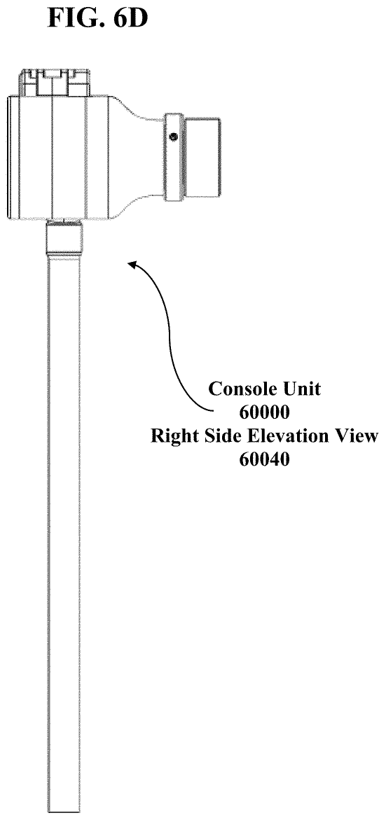

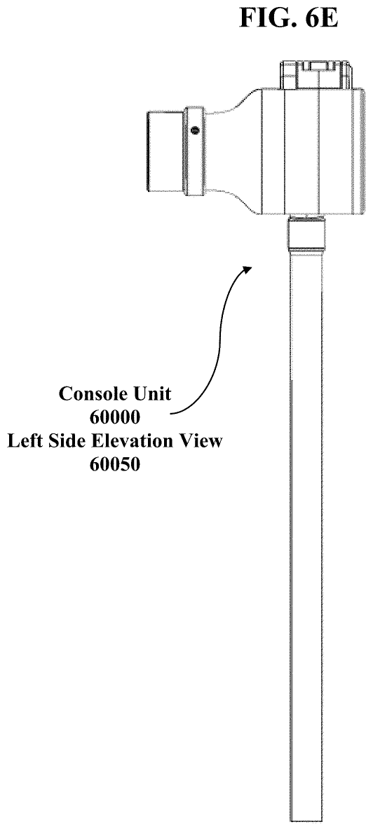

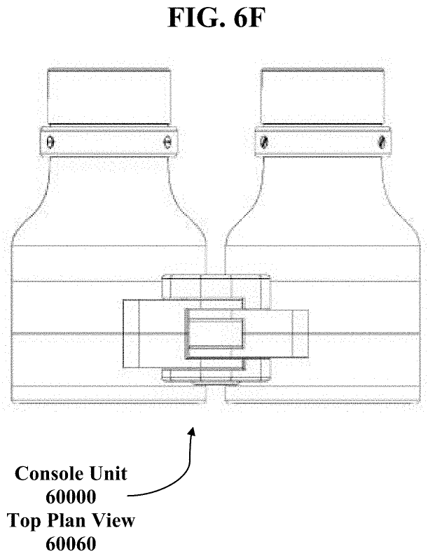

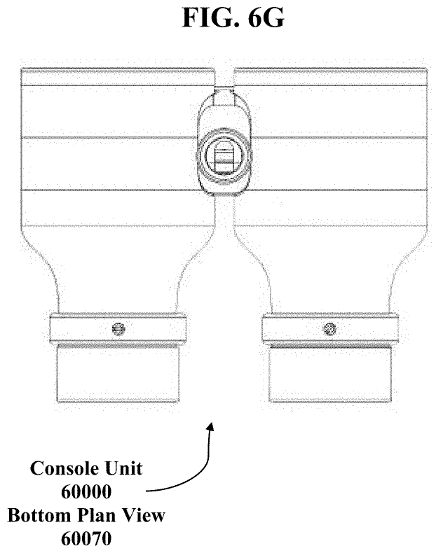

Referring to FIG. 6A to FIG. 6G, FIG. 6A to FIG. 6G show various views of an exemplary commercial embodiment of an Ovees™ console unit 60000, respectively a front right perspective view 60010, a front elevation view 60020, a rear elevation view 60030, a right side elevation view 60040, a left side elevation view 60050, a top plan view 60060, and a bottom plan view 60070, of an exemplary apparatus 60000, for use with systems and methods in accordance with an exemplary embodiment of the present invention, according to aspects of the invention. The commercial embodiment of the Ovees™ console unit 60000 presently interoperates with a separate break-out box (BOB) 33010, largely due to design factors involving manufacturing, costs, component capabilities, and the ability to exchange components. However, other embodiments of an AR apparatus 10000 may integrate the BOB 33010 and/or the BOB 33010 functions into the console 60000 to make a single unit 10000 that includes the functions and capabilities of the console 10010, 60000 and the BOB 330100. Integration of the BOB 33010 into the console 10010 may be more practical or affordable, for instance, as manufacturing scales up and associated manufacturing costs scale down, and/or as technological performance or capabilities scale up and associated technology costs scale down.

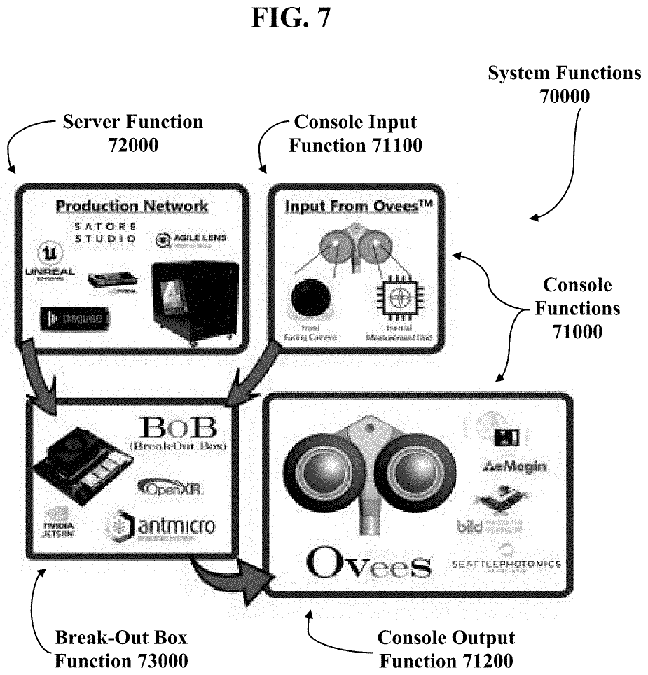

Referring to FIG. 7, FIG. 7 shows a conceptual block diagram of an exemplary system functions 70000 operation flow within systems and methods in accordance with an exemplary embodiment of the present invention, according to aspects of the invention. The embodiment of FIG. 7 depicts an exemplary commercial embodiment of the Ovees™ system and is not limiting of the invention overall. The depicted system functions 70000 conceptually may be divided into the console functions 71000, the server function 72000, and the break-out box function 73000. The console functions 71000 conceptually may be divided into the console input function 71100 and the console output function 71200. At a high conceptual level, the console input function 71100 comprises generating video data and positioning data from the Ovees™ console, and sending the video data and the positioning data to the break-out box. The break-out box function 73000 includes receiving the video data and the positioning data and communicating with the server to have the server perform the server function 72000 comprising generating an augmented reality overlay appropriate to the positioning data and timing of the positioning data relative to the events in the video data, and sending the AR overlay to the BOB. The break-out box function 73000 further includes combining the AR overlay with the video data to create an AR-overlaid video data feed, and sending the AR-overlaid video data feed to the console. The console output function 71200 includes displaying the AR-overlaid video data on the micro-displays of the console for viewing by a user.

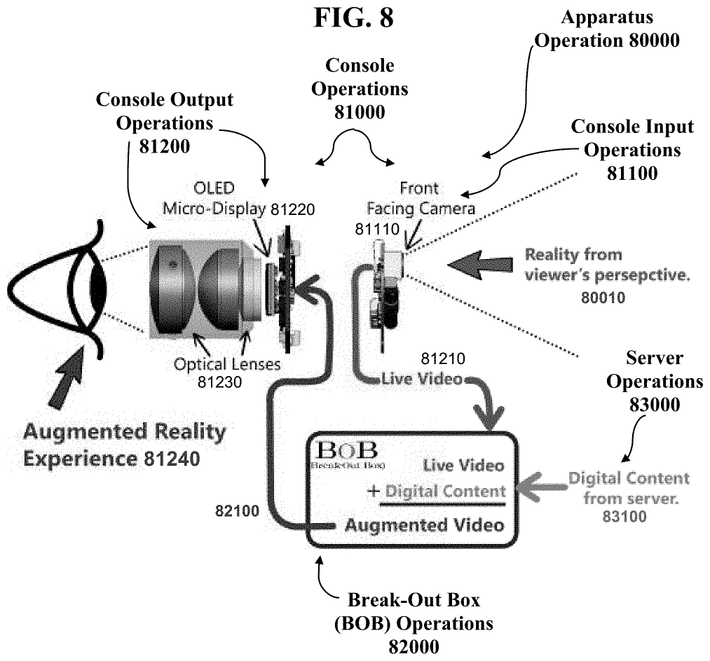

Referring to FIG. 8, FIG. 8 shows a conceptual block diagram of an exemplary apparatus operation 80000, as an apparatus within a system used pursuant to a method in accordance with an exemplary embodiment of the present invention, according to aspects of the invention. The embodiment of FIG. 8 depicts an exemplary commercial embodiment of the Ovees™ system and is not limiting of the invention overall. The depicted apparatus operation 80000 conceptually may be divided into the console operations 81000, the break-out box (BOB) operations 82000, and the server operations 83000. The console operations 81000 conceptually may be divided into the console input operations 81100 and the console output operations 81200. At a high conceptual level, the console input operations 81100 comprise generating video data using a front facing camera 81110 of a reality 80010, as viewed from a viewer's perspective, who is holding the camera 81110 to the viewer's face, and positioning data from the Ovees™ console, and sending the live video data 81210 and the positioning data to the break-out box. The break-out box operations 82000 include receiving the live video 81210 and the positioning data and communicating with the server to have the server perform the server operations 83000 comprising generating digital content 83100 that includes an augmented reality overlay appropriate to the positioning data and timing of the positioning data relative to the events in the video data, and sending the digital content 83100 from the server to the BOB. The break-out box operations 82000 further include combining aspects of the digital content 83100 as the AR overlay with the live video 81210 to create an augmented video 82100 data feed, and sending the augmented video 82100 data feed to the console. The console output operations 81200 include displaying the augmented video 82100 data on the OLED micro-displays 81220 of the console for viewing by a user through the optical lenses 81230 to create an augmented reality experience 81240.

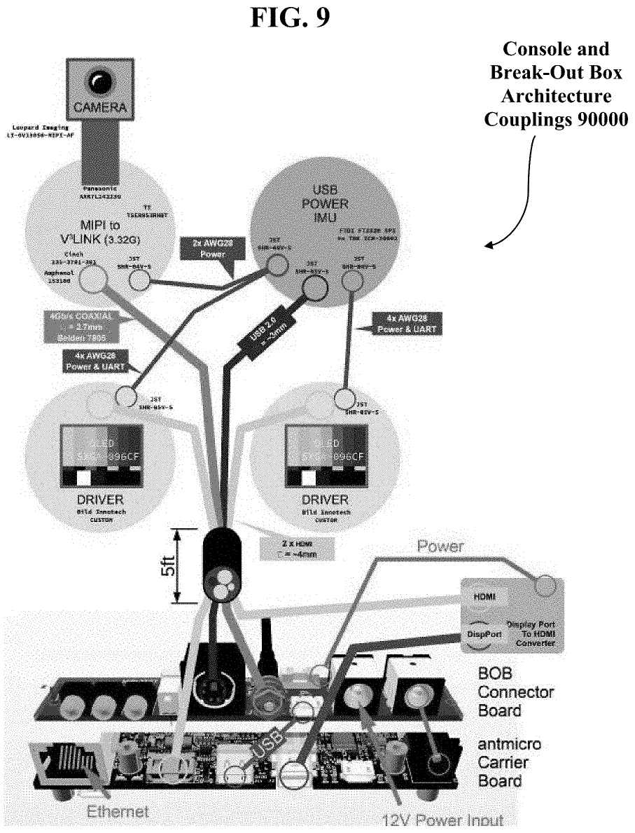

Referring to FIG. 9, FIG. 9 shows a conceptual pictographic diagram of an exemplary console and break-out box architecture 90000 and included couplings, as an apparatus 10000 within a system used pursuant to a method in accordance with an exemplary embodiment of the present invention, according to aspects of the invention. The embodiment of FIG. 9 depicts an exemplary commercial embodiment of the Ovees™ system and is not limiting of the invention overall. The pictographically depicted apparatus architecture 90000 includes the console and the break-out box separated by a 5 ft connection that includes couplings of a coaxial cable, HDMI cables, a USB cable, and power cables, among potentially other couplings. The console couplings also include couplings to a camera and two OLED micro-displays. The BOB couplings also include couplings to an Ethernet connection and to a power input. The Ethernet connection may enable communication with a server, and the power input may enable receipt of electricity from a twelve-volt (12V) direct current (DC) power source.

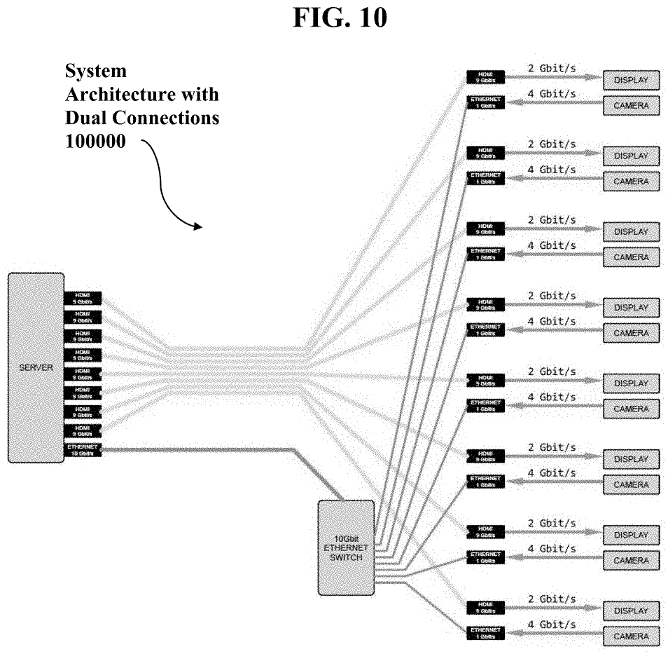

Referring to FIG. 10, FIG. 10 shows a block diagram of an exemplary system 100000, in accordance with an exemplary embodiment of the present invention, in which an architecture of the system 100000 includes dual wired connections for connections of a server to each of eight apparatus, each apparatus comprising a console paired with and coupled to a break-out box connecting to the server via a wired Ethernet connection and a wired HDMI connection, according to aspects of the invention. The dual connections may comprise the Ethernet connection for communication of non-video data (between the server and the apparatus) and the HDMI connection for communication of video data from the server to the apparatus. As depicted, an Ethernet network switch or network router may combine, route, and/or regulate the network communication traffic between the server and each apparatus. In contrast, as depicted, the HDMI connections are individual connections from the server to each apparatus for transmission of the AR overlay video data. In some embodiments, the Ethernet connection may be wireless instead of wired.

In this depicted system 100000, there is one server connected to eight Ovees™ apparatus. To support the Ovees™ apparatus, there are eight HDMI outputs and one Ethernet connection. All camera (plus IMU) data may be funneled to this single port, so the port would need to be quite efficient in decompressing eight streams with low latency, likely requiring 10 Gbit/s. For larger installations, this group may need to be multiplied for every eight Ovees™ apparatus. For example, 120 Ovees™ apparatus may require 120 HDMI cables coming from 15 servers.

Exemplary available bandwidths for display and camera are shown also. The bandwidth for the display (eMagin SXGA-096) to support 1280×1024 at 60 fps is less than 2 Gbit/s. Meanwhile, the bandwidth for the camera (On Semi AR0431C) has a higher capability of 2312×1746 resolution at 120 fps. So, in this exemplary embodiment, the camera data must be compressed considerably, which will add noise to the image and may make the machine-vision aspects of the system more complicated. In this exemplary embodiment, the maximum camera resolution and framerate may not be supported as a result.

In this exemplary embodiment, a difficulty with deployment may arise due to the large number of cables. In an alternative configuration, HDMI cables may be replaced with something smaller and allowing longer than 10-meter lengths, such as SDI-3G.

Latency also can be a difficulty to be managed. Both compression artifacts and system latency are caused by Ethernet limitations. Some numbers for a latency budget can be found from this video streaming white paper: https://www.intel.com/content/dam/www/programmable/us/en/pdfs/literature/wp/wp-cast-low-latency.pdf (see pg. 3). Below is Table 1, comprising a table of latencies for various technologies contemporaneous to this invention.

TABLE 1
Latencies for Processing Stages

| | | Latency |
|---|---|---|
| Processing Stage | Buffering | (1080p30) |
| Capture post-processing (e.g., | A few lines (e.g., 8) | <0.50 ms |
| Bayer filter, chroma resampling) | | |
| Video compression (e.g., | 16 lines for conversion from raster scan; | 0.49 ms~ |
| Motion-JPEG, MPEG-1/2/4 or | a few thousand pixels on the encoder | 0.01 ms |
| H.264 with single-pass bitrate | pipeline | |
| regulation) | | |
| Bit-Rate Averaging Buffer | From a number of frames (e.g., more | from 1 s |
| (BRAB) | than 30) to deep sub-frame (e.g., ¼ | to 8.33 ms |
| | frame) | |
| Network processing (e.g., | A few kilobytes (KB) | <0.01 ms |
| RTP/UDP/IP encapsulation) | | |
| Decoder Stream Buffer (DSB) | From a number of frames (e.g., more | from 1 s |
| | than 30) to sub-frame (e.g., ¼ frame) | to 8.33 ms |
| Video decompression (JPEG, | 16 lines for conversion from raster scan; | 0.49 ms~ |
| MPEG-1/2/4, or H.264) | a few thousand of pixels on the decoder | 0.01 ms |
| | pipeline | |
| Display pre-processing (e.g., | A few lines (e.g., 8) | <0.50 ms |
| Scaling, Chroma Resampling) | | |
| Display controller buffer | From one frame in most cases to a few | from 33.3 ms |
| | lines or tens of lines (e.g., 64) | to 2 ms |

The encoding for low-latency systems is typically Motion JPEG (MJPEG) or h.264 with minimal buffering. Reducing the buffer sizes to reduce the latency will also decrease the compression efficiencies. In some embodiments of the invention, the augmented reality content may be generated taking into account the latency within the system, as measured by the server in timing one-way and roundtrip data exchanges, wherein the positioning data are assumed to be momentarily constant during the latency of the data exchange roundtrip, and the augmented reality content is generated based on what the AR content should be in the momentary future once the AR content data are received by the apparatus.

For instance, using very high latencies as round numbers for ease of understanding (and not as parameters of the invention), assume positioning data are generated at t=0 seconds and received by the server at t=1 second; assume the server finishes generating the augmented reality content data at t=2 and sends the AR content data to the apparatus, which receives the AR content video data at t=3.5 seconds and finishes combining the AR content video data and the camera video data at t=4 seconds; and assume the AR-overlaid video data are rendered and displayed on the micro-display at t=4.5 seconds. Using these gross assumptions, the server could generate the AR overlay as the AR overlay should appear to a user at t=4.5 seconds, when the AR-overlaid video is displayed, based on the assumption that the positioning data would remain substantially unchanged in the time between t=0 and t=4.5 seconds. Due to issues of latency of sending positioning data to the server, and receiving back AR overlay data from the server, the apparatus, such as in a break-out box, may separate the positioning data and the camera video feed, such that the camera video feed is not tied to the positioning data generated simultaneously to the video feed. Instead, by untying the video feed from the positioning data, the most current video feed may be used in combining the AR overlay and the video feed, rather than combining the AR overlay with the older video feed generated when the positioning data were generated and transferred to the server, on which the AR overlay then was based. Using the current video feed provides rendering and displaying a video that is nearly real-time to events in reality. By analogy, think of a game of American football, in which a quarterback is throwing a football to a wide receiver: the quarterback may throw the football to the destination to which the wide receiver is running, and not to the location of the wide receiver at the moment the football is thrown, such that the football and the wider receiver both independently arrive at the destination at the same time, enabling the wide receiver to catch the football and complete the pass at the desired destination, such as the endzone to score a touchdown.

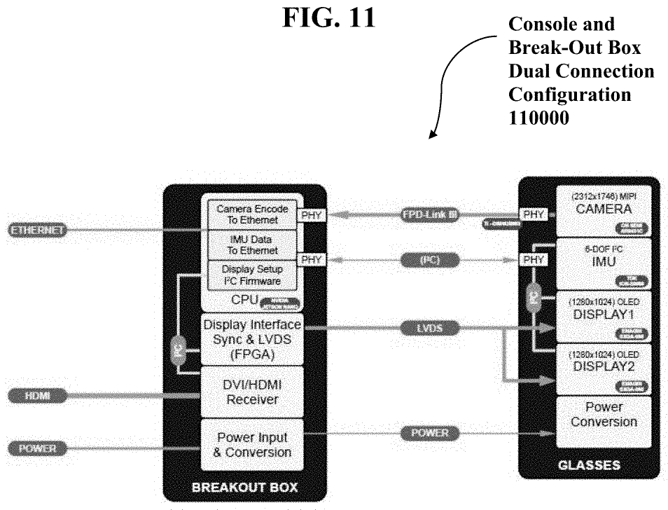

Referring to FIG. 11, FIG. 11 shows a block diagram of an exemplary configuration 110000 of an apparatus, comprising a console (i.e., glasses) and a break-out box having dual wired connections, in accordance with an exemplary embodiment of the present invention, in which dual wired connections are present for connections of a server to each apparatus, each apparatus comprising a console paired with and coupled to a break-out box connecting to the server via a wired Ethernet connection and a wired HDMI connection, according to aspects of the invention. The apparatus configuration 110000 may be used, for instance, in the exemplary system architecture 100000 depicted FIG. 10.

FIG. 11 depicts an exemplary embodiment of an Ovees™ unit in accordance with aspects of the invention. For each user location, each of the critical path and bandwidth limitation is sending the camera data to Ethernet. In some embodiments, this function could be done with specialized hardware such as an FPGA, or with a just right sized CPU like a cell phone processor (Qualcomm Snapdragon). In the exemplary embodiment, a powerful CPU in a very small form factor has been chosen, Nvidia Jetson Nano (Module), which is more supported for independent developers, while also allowing for maximum scalability for large deployments. Some exemplary processors and parameters include: (1) FPGA: Lowest latency; Higher debug/development costs; Licensing required; (2) Snapdragon ARM CPU: Likely low latency; Unknown development costs; “Pokémon Go” style capabilities; (3) Jetson: Low latency; Slightly larger and higher power; Allows for localized rendering.

An interesting characteristic of the Jetson series of CPUs is they contain a powerful GPU that could drive the displays directly. In such an exemplary configuration, rather than camera video making a round-trip to the server, each GPU receives common data, like a video stream and/or point cloud for 3D objects. In this configuration, the Ethernet bandwidth is drastically lowered when only one common data stream is broadcast to all the Ovees™ units. This type of installation for eight Ovees™ units is shown in the following Figure C that depicts an Ethernet-Only System Diagram.

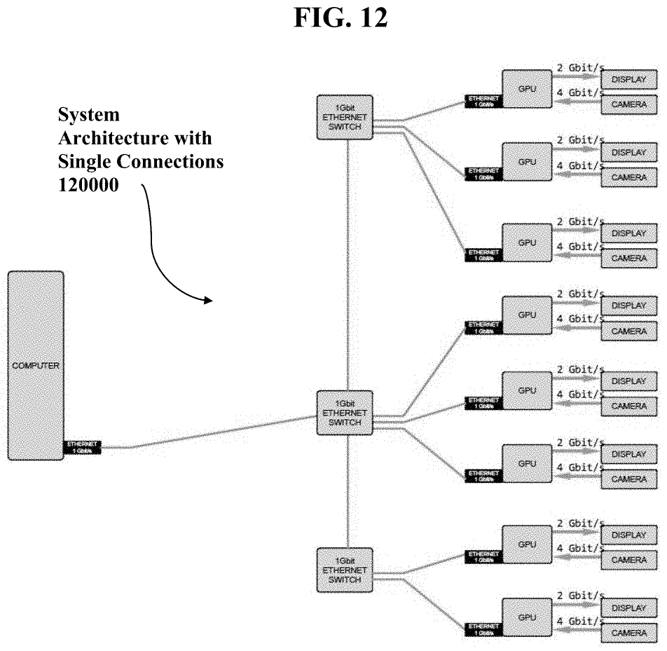

Referring to FIG. 12, FIG. 12 shows a block diagram of another exemplary system 120000, in accordance with another exemplary embodiment of the present invention, in which the system 120000 has an architecture having single wired or wireless Ethernet connections for connections of a server to each of eight apparatus, each apparatus comprising a console paired with and coupled to a break-out box having a wired or wireless Ethernet connection to the server, according to aspects of the invention. In contrast to the system 100000 depicted in FIG. 10, the system 120000 uses the Ethernet connection both for communication of non-video data (between the server and the apparatus) and for communication of video data from the server to the apparatus. Because system 120000 uses a single connection for communication between the server and each apparatus, that single connection may be a single wireless connection, which would require that the wireless hardware and software are robust enough to handle the data communications for the given number of apparatus. For instances, use of a 5G wireless system hardware and software may enable data communications having sufficiently low latencies to permit an acceptable user experience in using the console in viewing an AR-overlaid video of a live performance. For instance, a cell tower, a wireless network switch, or a wireless network router may connect to, and combine, route, and/or regulate, the wireless network communication traffic between the server and each apparatus.

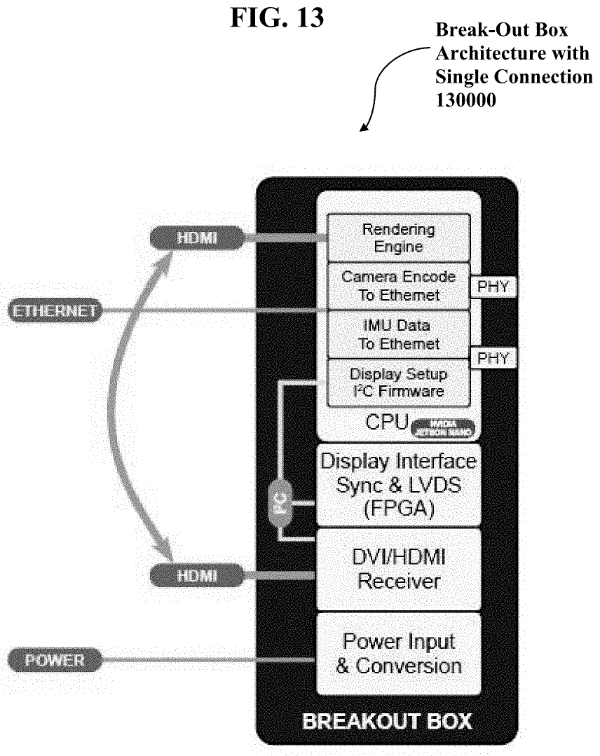

FIG. 12 depicts a block diagram of what also may be called an Ethernet-Only System 120000, in accordance with exemplary aspects of the invention. In this exemplary embodiment, the breakout box adds an HDMI output from the Jetson processor. Using a short HDMI cable, this connection can be looped back into the HDMI input, and thus these HDMI connections to the server are removed, as depicted in FIG. 13.

Referring to FIG. 13, FIG. 13 shows a block diagram of another exemplary configuration of a break-out box architecture 130000, in which the break-out box has a single wired connection to a server, and the break-out box is to be separately coupled to a console, in accordance with an exemplary embodiment of the present invention. Architecture 130000 may be used, for instance, in a wired version of the system 120000 depicted in FIG. 12. In the architecture 130000, the single wired Ethernet connection is used for connection of a server to each apparatus, each apparatus comprising a console paired with and coupled to a break-out box having a wired Ethernet connection to the server, according to aspects of the invention.

FIG. 13 depicts a block diagram of what also may be called an Ethernet-Only Breakout Box 130000, in accordance with exemplary aspects of the invention.

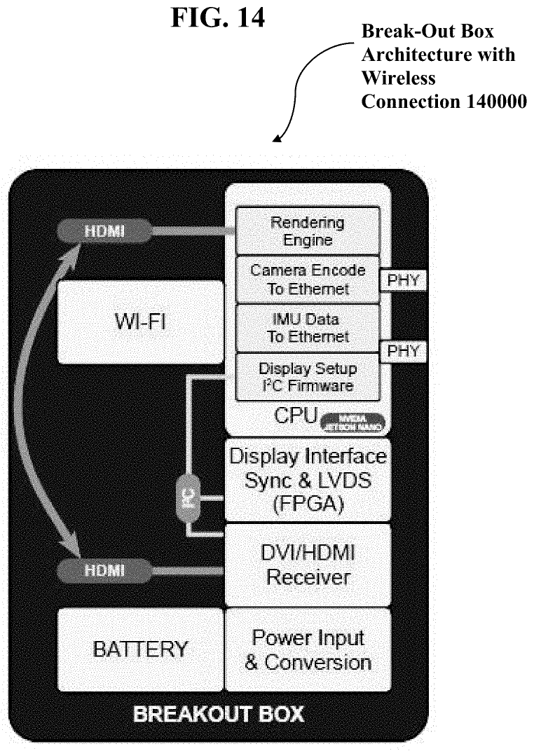

Referring to FIG. 14, FIG. 14 shows a block diagram of a further exemplary configuration of a break-out box architecture 140000, in which the break-out box has a single wireless connection to a server, and the break-out box is to be separately coupled to a console, in accordance with a further exemplary embodiment of the present invention. Architecture 140000 may be used, for instance, in a wireless version of the system 120000 depicted in FIG. 12. In the architecture 140000, the single wireless connection is used for connection of a server to each apparatus, each apparatus comprising a console paired with and coupled to a break-out box having a wireless transceiver, according to aspects of the invention.

FIG. 14 depicts a block diagram of what also may be called an a Fully Wireless Breakout Box 140000 in a unit for use in a Wireless-Supported System in accordance with exemplary aspects of the invention. In this exemplary embodiment 140000, this new design includes an upgraded revision including a Wi-Fi transceiver and a battery.

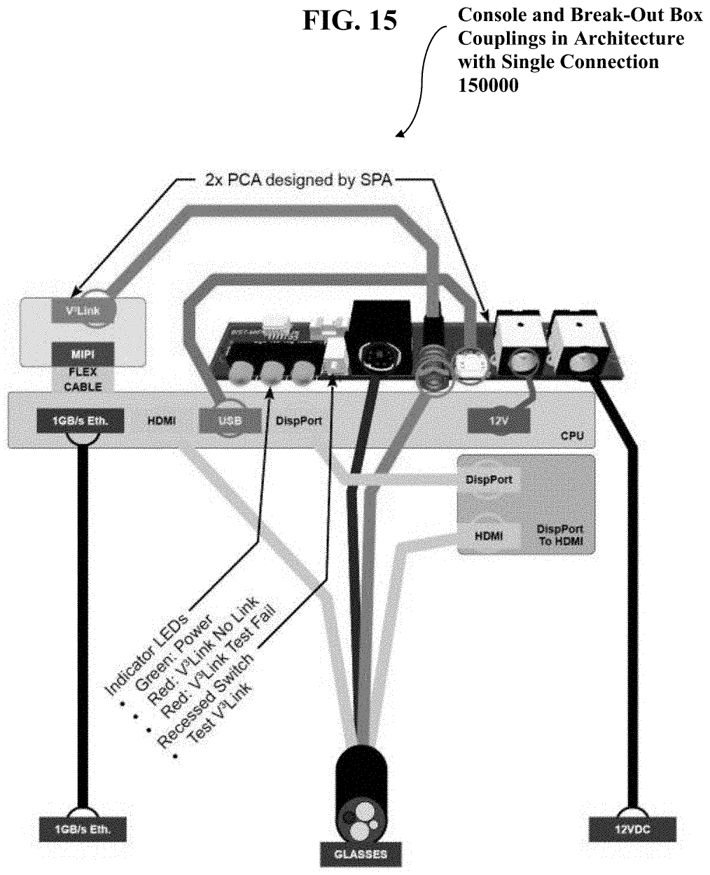

Referring to FIG. 15, FIG. 15 shows a conceptual pictographic diagram of exemplary couplings in an architecture 150000 of a break-out box having a single wired connection to a server, and the break-out box separately coupled to a console (i.e., glasses), in accordance with an exemplary embodiment of the present invention. Architecture 150000 may represent pictographically the couplings of an apparatus using the break-out box architecture 130000. Architecture 150000 may be used, for instance, in a wired version of the system 120000 depicted in FIG. 12. In the architecture 150000, the single wired Ethernet connection is present for connection of a server to the apparatus, the apparatus comprising a console paired with and coupled to a break-out box having a wired Ethernet connection to the server, according to aspects of the invention.

FIG. 15 depicts a conceptual pictographic diagram of what also may be called an exemplary Ovees™ unit Breakout Box (BOB) in accordance with aspects of the invention.

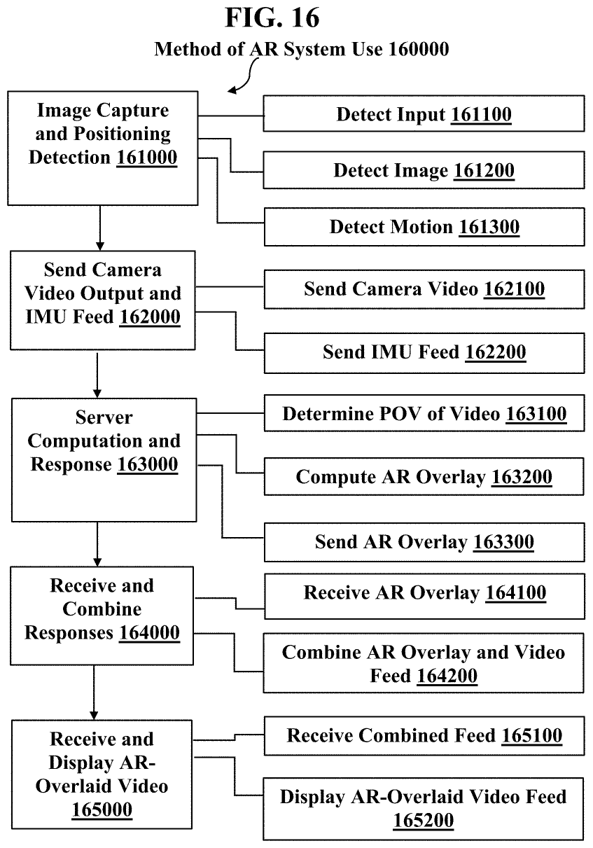

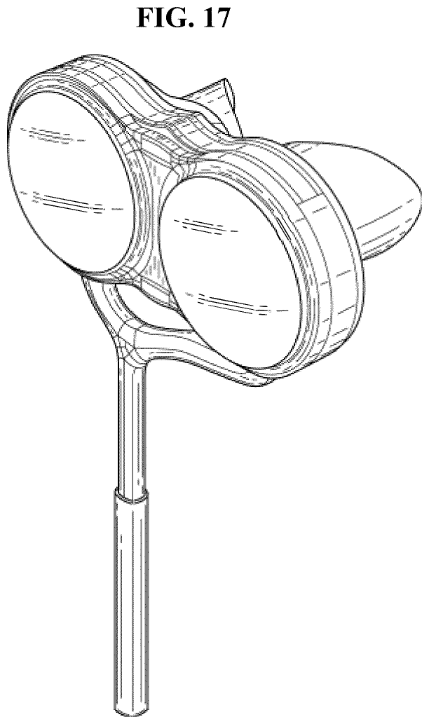

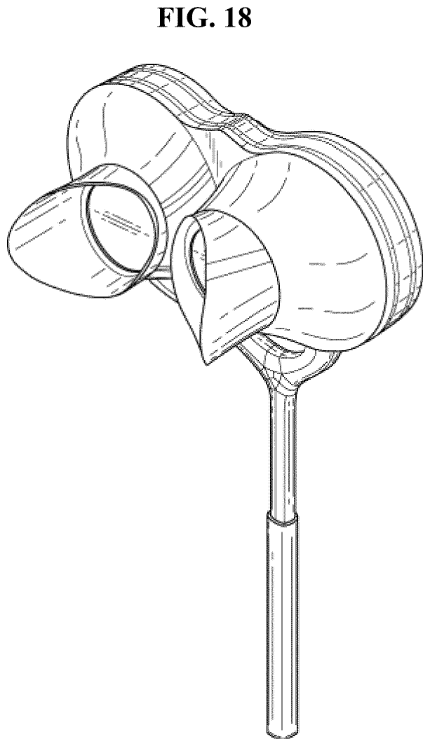

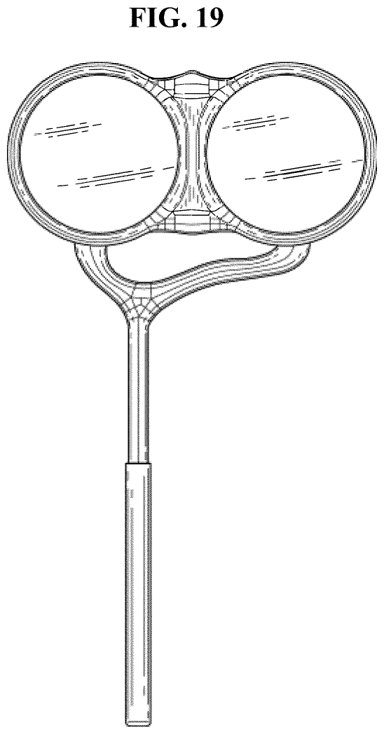

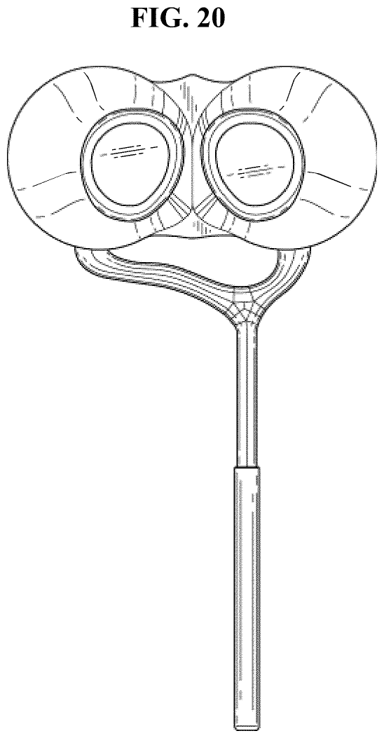

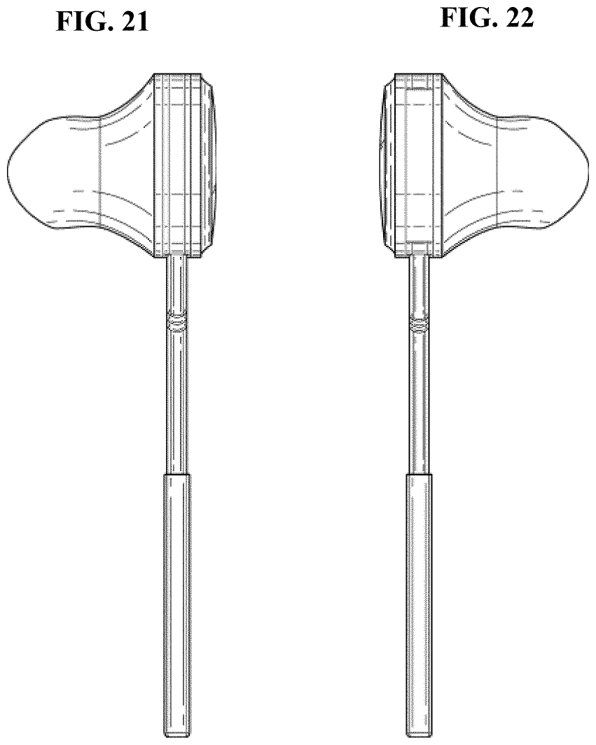

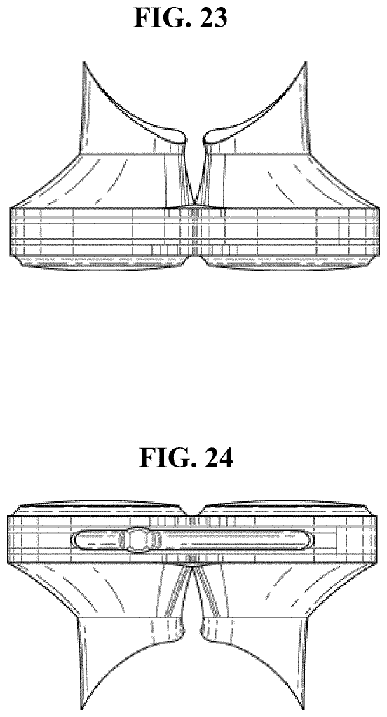

Referring to FIG. 16, FIG. 16 shows a block diagram of an exemplary embodiment of a method 160000 of use of an exemplary AR system, according to prior art of the invention. In the method 160000 as depicted in FIG. 16, the AR system may perform a step 161000 of image capture and positioning detection at the apparatus. The image capture and positioning detection step 161000 may include, for instance, detecting 161100 an input, such as a button press to activate the apparatus; detecting 161200 an image captured by a camera of the apparatus, such as in which the image is detected during a concert or performance, and possibly using machine vision or AI to identify the start of a concert or performance; and detecting motion 161300, such as to generate positioning data and/or to indicate that the apparatus is being moved or handled by a user. The AR system may perform a step 162000 at the apparatus of transmission of camera video output and IMU feed from the console to the break-out box. This transmission step 162000 may include sending 162100 the camera video from the camera to the break-out box for combination with an AR overlay, and sending 162200 the IMU feed from the break-out box to the server for positioning calculations and determinations of the appropriate AR overlay. The AR system may perform a step 163000 at the server of server computation and response to the transmission step 162000. This computation and response step 163000 may include determining 163100 a point of view (POV) of the camera video, computing 163200 an AR overlay appropriate to the camera position and POV, and sending 163300 the AR overlay to the apparatus. The AR system may perform a step 164000 at the apparatus of receipt and combination of responses from the server. The receipt and combination of responses step 164000 may include receiving 164100 the AR overlay and combing 164200 the AR overlay and the video feed. The AR system may perform the step 165000 at the apparatus of receipt and display of the AR-overlaid video. The receipt and display of AR-overlaid video step 165000 may include receiving 165100 the combined feed comprising the AR-overlaid video, and displaying 165200 the AR-overlaid video feed on the micro-displays of the console.

The foregoing description discloses exemplary embodiments of the invention. While the invention herein disclosed has been described by means of specific embodiments and applications thereof, numerous modifications and variations could be made thereto by those skilled in the art without departing from the scope of the invention set forth in the claims. Modifications of the above disclosed apparatus and methods that fall within the scope of the claimed invention will be readily apparent to those of ordinary skill in the art. Accordingly, other embodiments may fall within the spirit and scope of the claimed invention, as defined by the claims that follow hereafter.

In the description above, numerous specific details are set forth in order to provide a more thorough understanding of embodiments of the invention. It will be apparent, however, to an artisan of ordinary skill that the invention may be practiced without incorporating all aspects of the specific details described herein. Not all possible embodiments of the invention are set forth verbatim herein. A multitude of combinations of aspects of the invention may be formed to create varying embodiments that fall within the scope of the claims hereafter. In addition, specific details well known to those of ordinary skill in the art have not been described in detail so as not to obscure the invention. Readers should note that although examples of the invention are set forth herein, the claims, and the full scope of any equivalents, are what define the metes and bounds of the invention protection.

What is claimed:

1. An apparatus, the apparatus adapted for use in displaying computer-generated content, the apparatus comprising:
electronic circuitry and hardware including:
a processor;
a camera, the camera coupled to the processor;
a display, the display coupled to the processor;
a memory, the memory coupled to the processor;
a positioning device, the positioning device coupled to the processor;
a data transfer module, the data transfer module coupled to the processor;
a data transfer device, the data transfer device coupled to the processor;
electronic software, the software stored in the electronic circuitry and hardware and adapted to enable, drive, and control the electronic circuitry and hardware;
an optical lens assembly, the optical lens assembly adapted to magnify and to focus an image rendered and displayed on the display;
a power supply connection, the power supply connection coupled to the electronic circuitry and hardware and couplable to a power supply; and
a housing, the housing comprising an interior and an exterior housing, the interior containing the electronic circuitry and hardware, the software, and the power supply connection; and the exterior housing comprising a frame enclosing the optical lens assembly;
wherein the positioning device is adapted to generate positioning data indicative of at least one parameter of a group consisting of a position, a location, an orientation, a movement, and a point of view of the apparatus;
wherein the computer-generated content includes dynamic content changing over time and space in real-time as related events in reality occur;
wherein the dynamic content is selected from a content group consisting of augmented reality content and virtual reality content;
wherein the computer-generated content comprises computer-generated content data encoding video;
wherein the computer-generated content and computer-generated content data are adapted to be generated based on the positioning data;
wherein the computer-generated content is customized to the apparatus based on the computer-generated content data being generated after, but nearly simultaneous to, generation of the positioning data;
wherein the computer-generated content is rendered and displayed on the display after, but nearly simultaneous to, generation of the computer-generated content; and
wherein an occurrence of data generated, rendered, or displayed after, but nearly simultaneous to, generation of other data occurs within a latency not to exceed one second.

2. The apparatus of claim 1, wherein:
the computer-generated content comprises augmented reality content;
the augmented reality content corresponds to and augments the related events in reality occurring in real-time;
the augmented reality content comprises an augmented reality overlay;
the augmented reality overlay comprises augmented reality overlay data encoding video adapted to be combined with and overlaid over video data generated by the camera after, but nearly simultaneous to, generation of the augmented reality overlay data; and
a combination of the augmented reality overlay and the video data comprises an augmented-reality-overlaid video encoded by augmented-reality-overlaid video data adapted to be rendered and displayed on the display.

3. The apparatus of claim 2, wherein:
the augmented reality content is generated by a server electronically coupled to the data transfer device and in communication with the data transfer module;
the data transfer device is adapted to transfer the positioning data to the server; and
the server receives the positioning data, generates the augmented reality content based on the positioning data, and transmits the augmented reality content to the data transfer device.

4. The apparatus of claim 1, wherein:
the computer-generated content comprises augmented reality content;
the computer-generated content is adapted to be displayed as augmented reality content, and
the apparatus is adapted for use in displaying augmented reality content.

5. The apparatus of claim 1, wherein:
the computer-generated content comprises virtual reality content;
the computer-generated content is adapted to be displayed as virtual reality content, and
the apparatus is adapted for use in displaying virtual reality content.

6. The apparatus of claim 1, wherein:
the positioning device comprises at least one of a group consisting of an accelerometer, an inertia motion unit (IMU), an infrared sensor, a gyroscope, a light detection and ranging (LiDAR) unit, and a global positioning system (GPS) unit.

7. The apparatus of claim 1, wherein:
the software includes an application and a configuration file for the application that are adapted to enable, drive, and control the computer-generated content, and to render the computer-generated content on the display.

8. The apparatus of claim 1, wherein:
the optical lens assembly comprises a left-eye lens assembly and a right-eye lens assembly;
the left-eye lens assembly is adapted for use by a left eye of a user;
the right-eye lens assembly is adapted for use by a right eye of a user;
the display comprises a left-eye display and a right-eye display;
the left-eye display is paired with the left-eye lens assembly;
the right-eye display is paired with the right-eye lens assembly;
the apparatus is adapted to generate and to display a stereoscopic 3D video comprising the computer-generated content;
the stereoscopic 3D video comprises a left-eye video feed and a right-eye video feed;
the left-eye video feed is adapted to be displayed on the left-eye display; and
the right-eye video feed is adapted to be displayed on the right-eye display.

9. The apparatus of claim 8, wherein:
each optical lens assembly includes an eye cup adapted to conform to a shape of a user's face surrounding an eye socket of the user;
that the left-eye lens assembly includes a left-eye eye cup adapted to fit the user's left eye;
the right-eye lens assembly includes a right-eye eye cup adapted to fit the user's right eye;
the frame and the optical lens assemblies resemble a pair of binoculars;
the housing comprises a handle that extends below the frame; and
the handle and the pair of binoculars resemble a pair of opera glasses.

10. The apparatus of claim 1, wherein:
the optical lens assembly includes an eye cup adapted to conform to a shape of a user's face surrounding an eye socket of the user.

11. The apparatus of claim 1, wherein:
the data transfer device comprises a wireless transceiver.

12. The apparatus of claim 1, wherein:
the housing comprises a handle that extends below the frame.

13. The apparatus of claim 1, wherein:
the electronic circuitry and hardware and the electronic software further comprise a console and an intermediate computing device;
the console comprises the processor, the camera, the display, the memory, the positioning device, the data transfer module, the data transfer device, related aspects of the software, the housing, the power supply connection, and the optical lens assembly;
the console may be referred to as a viewer;
the intermediate computing device comprises another processor, another memory, another data transfer module, another data transfer device, other aspects of the software, another housing, and another power supply connection;
the intermediate computing device may be referred to as a breakout box;
the breakout box is electronically couplable to the console; and,
the breakout box is adapted to handle aspects of data transfer and data processing separately from the console in generating, transferring, and processing the computer-generated content.

14. A system, the system adapted for use in displaying computer-generated content, the system comprising:
a server; and
an apparatus, the apparatus adapted to be coupled to and in communication with the server;
wherein the server comprises:
server electronic circuitry and hardware including:
a server processor;
a server memory, the server memory coupled to the server processor;
a server data transfer module, the server data transfer module coupled to the server processor;
a server data transfer device, the server data transfer device coupled to the server processor;
server electronic software, the server software stored in the server electronic circuitry and hardware and adapted to enable, drive, and control the server electronic circuitry and hardware; and
a server power supply connection, the server power supply connection coupled to the server electronic circuitry and hardware and couplable to a server power supply;
wherein the apparatus comprises:
apparatus electronic circuitry and hardware including:
an apparatus processor;
an apparatus camera, the apparatus camera coupled to the apparatus processor;
an apparatus display, the apparatus display coupled to the apparatus processor;
an apparatus memory, the apparatus memory coupled to the apparatus processor;
an apparatus positioning device, the apparatus positioning device coupled to the apparatus processor;
an apparatus data transfer module, the apparatus data transfer module coupled to the apparatus processor;
an apparatus data transfer device, the apparatus data transfer device coupled to the apparatus processor;
apparatus electronic software, the apparatus software stored in the apparatus electronic circuitry and hardware and adapted to enable, drive, and control the apparatus electronic circuitry and hardware;
an apparatus optical lens assembly, the apparatus optical lens assembly adapted to magnify and to focus an image rendered and displayed on the apparatus display;
an apparatus power supply connection, the apparatus power supply connection coupled to the apparatus electronic circuitry and hardware and couplable to an apparatus power supply; and
an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing the apparatus optical lens assembly;
wherein the apparatus positioning device is adapted to generate positioning data indicative of at least one parameter of a group consisting of a position, a location, an orientation, a movement, and a point of view of the apparatus;
wherein the apparatus is adapted to transmit the positioning data to the server;
wherein the apparatus is adapted to receive the computer-generated content from the server;
wherein the server is adapted to generate the computer-generated content based on receiving the positioning data from the apparatus;
wherein the server is adapted to transmit the computer-generated content to the apparatus upon generation of the computer-generated content;
wherein the computer-generated content includes dynamic content changing over time and space in real-time as related events in reality occur;
wherein the dynamic content is selected from a content group consisting of augmented reality content and virtual reality content;
wherein the computer-generated content comprises computer-generated content data encoding video;
wherein the computer-generated content and computer-generated content data are adapted to be generated by the server based on the positioning data;
wherein the computer-generated content is customized to the apparatus based on the computer-generated content data being generated after, but nearly simultaneous to, generation of the positioning data;
wherein the computer-generated content is rendered and displayed on the apparatus display after, but nearly simultaneous to, generation of the computer-generated content by the server; and
wherein an occurrence of data generated, rendered, or displayed after, but nearly simultaneous to, generation of other data occurs within a latency not to exceed one second.

15. The system of claim 14, wherein:
the computer-generated content comprises augmented reality content;
the augmented reality content corresponds to and augments the related events in reality occurring in real-time;
the augmented reality content comprises an augmented reality overlay;
the augmented reality overlay comprises augmented reality overlay data encoding video adapted to be combined with and overlaid over video data generated by the apparatus camera after, but nearly simultaneous to, generation of the augmented reality overlay data by the server; and
a combination of the augmented reality overlay and the video data comprises an augmented-reality-overlaid video encoded by augmented-reality-overlaid video data adapted to be rendered and displayed on the display.

16. The system of claim 14, wherein:
the optical lens assembly comprises a left-eye lens assembly and a right-eye lens assembly;
the left-eye lens assembly is adapted for use by a left eye of a user;
the right-eye lens assembly is adapted for use by a right eye of a user;
the display comprises a left-eye display and a right-eye display;
the left-eye display is paired with the left-eye lens assembly;
the right-eye display is paired with the right-eye lens assembly;
the apparatus is adapted to generate and to display a stereoscopic 3D video comprising the computer-generated content;
the stereoscopic 3D video comprises a left-eye video feed and a right-eye video feed;
the left-eye video feed is adapted to be displayed on the left-eye display; and
the right-eye video feed is adapted to be displayed on the right-eye display.

17. The system of claim 16, wherein:
each optical lens assembly includes an eye cup adapted to conform to a shape of a user's face surrounding an eye socket of the user;
that the left-eye lens assembly includes a left-eye eye cup adapted to fit the user's left eye;
the right-eye lens assembly includes a right-eye eye cup adapted to fit the user's right eye;
the frame and the optical lens assemblies resemble a pair of binoculars;
the housing comprises a handle that extends below the frame; and
the handle and the pair of binoculars resemble a pair of opera glasses.

18. The system of claim 14, wherein:
the apparatus data transfer device comprises an apparatus wireless transceiver;
and,
the server data transfer device comprises a server wireless transceiver.

19. The system of claim 14, wherein:
the electronic circuitry and hardware and the electronic software further comprise a console and an intermediate computing device;
the console comprises the processor, the camera, the display, the memory, the positioning device, the data transfer module, the data transfer device, related aspects of the software, the housing, the power supply connection, and the optical lens assembly;
the console may be referred to as a viewer;
the intermediate computing device comprises another processor, another memory, another data transfer module, another data transfer device, other aspects of the software, another housing, and another power supply connection;
the intermediate computing device may be referred to as a breakout box;
the breakout box is electronically couplable to the console; and,
the breakout box is adapted to handle aspects of data transfer and data processing separately from the console in generating, transferring, and processing the computer-generated content.

20. A method, the method adapted for use in displaying computer-generated content, the method comprising:
providing an apparatus, the apparatus adapted to be coupled to and in communication with a server;
wherein the apparatus comprises:
apparatus electronic circuitry and hardware including:
an apparatus processor;
an apparatus camera, the apparatus camera coupled to the apparatus processor;
an apparatus display, the apparatus display coupled to the apparatus processor;
an apparatus memory, the apparatus memory coupled to the apparatus processor;
an apparatus positioning device, the apparatus positioning device coupled to the apparatus processor;
an apparatus data transfer module, the apparatus data transfer module coupled to the apparatus processor;
an apparatus data transfer device, the apparatus data transfer device coupled to the apparatus processor;
apparatus electronic software, the apparatus software stored in the apparatus electronic circuitry and hardware and adapted to enable, drive, and control the apparatus electronic circuitry and hardware;
an apparatus optical lens assembly, the apparatus optical lens assembly adapted to magnify and to focus an image rendered and displayed on the apparatus display;
an apparatus power supply connection, the apparatus power supply connection coupled to the apparatus electronic circuitry and hardware and couplable to an apparatus power supply; and
an apparatus housing, the apparatus housing comprising an apparatus interior and an apparatus exterior housing, the apparatus interior containing the apparatus electronic circuitry and hardware, the apparatus software, and the apparatus power supply connection; and the apparatus exterior housing comprising an apparatus frame enclosing the apparatus optical lens assembly;
wherein the apparatus positioning device is adapted to generate positioning data indicative of at least one parameter of a group consisting of a position, a location, an orientation, a movement, and a point of view of the apparatus;
wherein the apparatus is adapted to transmit the positioning data to the server;
wherein the apparatus is adapted to receive the computer-generated content from the server;
wherein the computer-generated content includes dynamic content changing over time and space in real-time as related events in reality occur;
wherein the dynamic content is selected from a content group consisting of augmented reality content and virtual reality content;
wherein the computer-generated content comprises computer-generated content data encoding video;
wherein the computer-generated content and computer-generated content data are adapted to be generated by the server based on the positioning data;
wherein the computer-generated content is customized to the apparatus based on the computer-generated content data being generated after, but nearly simultaneous to, generation of the positioning data;
wherein the computer-generated content is rendered and displayed on the apparatus display after, but nearly simultaneous to, generation of the computer-generated content by the server; and
wherein an occurrence of data generated, rendered, or displayed after, but nearly simultaneous to, generation of other data occurs within a latency not to exceed one second;
generating the positioning data of and by the apparatus;
transmitting the positioning data from the apparatus to the server;
receiving the computer-generated content at the apparatus from the server; and
rendering and displaying the computer-generated content on the apparatus display.

21. The method of claim 20, the method further comprising:
providing a server;
wherein the server comprises:
server electronic circuitry and hardware including:
a server processor;
a server memory, the server memory coupled to the server processor;
a server data transfer module, the server data transfer module coupled to the server processor;
a server data transfer device, the server data transfer device coupled to the server processor;
server electronic software, the server software stored in the server electronic circuitry and hardware and adapted to enable, drive, and control the server electronic circuitry and hardware; and
a server power supply connection, the server power supply connection coupled to the server electronic circuitry and hardware and couplable to a server power supply;
wherein the server is adapted to generate the computer-generated content based on receiving the positioning data from the apparatus;
wherein the server is adapted to transmit the computer-generated content to the apparatus upon generation of the computer-generated content;
receiving the positioning data at and by the server from the apparatus;
generating the computer-generated content at and by the server based on the positioning data; and
transmitting the computer-generated content by and from the server to the apparatus;

22. The method of claim 20, the method further comprising:
generating video data by the apparatus camera;
combining the video data in a video data feed with the computer-generated content;
overlaying the computer-generated content over the video data feed; and,
displaying on the apparatus display the combination of the computer-generated content overlaid over the video data feed;
wherein the computer-generated content comprises augmented reality content;
wherein the augmented reality content corresponds to and augments the related events in reality occurring in real-time;
wherein the augmented reality content comprises an augmented reality overlay;
wherein the augmented reality overlay comprises augmented reality overlay data encoding video adapted to be combined with and overlaid over video data generated by the apparatus camera after, but nearly simultaneous to, generation of the augmented reality overlay data by the server; and
wherein a combination of the augmented reality overlay and the video data comprises an augmented-reality-overlaid video encoded by augmented-reality-overlaid video data adapted to be rendered and displayed on the display.

23. The method of claim 20, the method further comprising:
generating a stereoscopic 3D video comprising the computer-generated content; and
displaying the stereoscopic 3D video on the apparatus;
wherein the apparatus optical lens assembly comprises a left-eye lens assembly and a right-eye lens assembly;
wherein the left-eye lens assembly is adapted for use by a left eye of a user;
wherein the right-eye lens assembly is adapted for use by a right eye of a user;
wherein the apparatus display comprises a left-eye display and a right-eye display;
wherein the left-eye display is paired with the left-eye lens assembly;
wherein the right-eye display is paired with the right-eye lens assembly;
wherein the apparatus is adapted to generate and to display the stereoscopic 3D video comprising the computer-generated content;
wherein the stereoscopic 3D video comprises a left-eye video feed and a right-eye video feed;
wherein the left-eye video feed is adapted to be displayed on the left-eye display; and
wherein the right-eye video feed is adapted to be displayed on the right-eye display.

24. The method of claim 23, wherein:
each apparatus optical lens assembly includes an eye cup adapted to conform to a shape of a user's face surrounding an eye socket of the user;
wherein that the left-eye lens assembly includes a left-eye eye cup adapted to fit the user's left eye;
wherein the right-eye lens assembly includes a right-eye eye cup adapted to fit the user's right eye;
wherein the apparatus frame and the apparatus optical lens assemblies resemble a pair of binoculars;
wherein the apparatus housing comprises a handle that extends below the apparatus frame; and
wherein the handle and the pair of binoculars resemble a pair of opera glasses.

25. The method of claim 20, the method further comprising:
wirelessly transmitting the positioning data from the apparatus to the server;
wirelessly receiving the positioning data at the server from the apparatus;
wirelessly transmitting the computer-generated content from the server to the apparatus; and
wirelessly receiving the computer-generated content at the apparatus from the server;
wherein the apparatus data transfer device comprises an apparatus wireless transceiver; and,
wherein the server data transfer device comprises a server wireless transceiver.

26. The method of claim 20, the method further comprising:
using an intermediate computing device to transmit the positioning data to the server;
using the intermediate computing device to receive the computer-generated content from the server; and
using the intermediate computing device to process the computer-generated content for displaying the computer-generated content on the apparatus display;
wherein the electronic circuitry and hardware and the electronic software further comprise a console and the intermediate computing device;
wherein the console comprises the apparatus processor, the apparatus camera, the apparatus display, the apparatus memory, the apparatus positioning device, the apparatus data transfer module, the apparatus data transfer device, related aspects of the apparatus software, the apparatus housing, the apparatus power supply connection, and the apparatus optical lens assembly;
wherein the console may be referred to as a viewer;
wherein the intermediate computing device comprises another processor, another memory, another data transfer module, another data transfer device, other aspects of the apparatus software, another housing, and another power supply connection;
wherein the intermediate computing device may be referred to as a breakout box;
wherein the breakout box is electronically couplable to the console; and,
wherein the breakout box is adapted to handle aspects of data transfer and data processing separately from the console in generating, transferring, and processing the computer-generated content.
